(19) United States
(12) Patent Application Publication
(10) Pub. No.: US 2025/0220396 A1
(43) Pub. Date: Jul. 3, 2025

(54) INFORMATION PROCESSING DEVICE, INFORMATION PROCESSING METHOD, AND INFORMATION PROCESSING PROGRAM

(71) Applicant: Sony Group Corporation, Tokyo (JP)

(72) Inventor: Takeshi YAMAZAKI, Kanagawa (JP)

(73) Assignee: Sony Group Corporation, Tokyo (JP)

(21) Appl. No.: 18/850,060

(22) PCT Filed: Mar. 3, 2023
(86) PCT No.: PCT/JP2023/007935

§ 371 Date: Sep. 24, 2024

(30) Foreign Application Priority Data
Apr. 1, 2022 (JP) 2022-061923

(51) Int. Cl. H04W 4/20; H04W 4/029

(52) U.S. Cl. CPC H04W 4/20; H04W 4/029

(57) ABSTRACT

An information processing device (10) according to an embodiment includes: a service management unit (120) that manages a notification position for providing notification of provision of a service corresponding to a degree of interest of a user, the notification position being arranged with respect to map information, and a user management unit (110) that acquires, based on the map information, a position of a user terminal (20) identified based on identification information for identifying the user and transmits notification to the user terminal (20) when the position of the user terminal (20) is within a notification range of the notification position.

### FIELD

The present disclosure relates to an information processing device, an information processing method, and an information processing program.

### BACKGROUND

In some store or the like, a beacon transmitter that transmits a beacon is installed at a place where content such as an electronic coupon is desired to be recommended to a user who has visited the store. A customer who has visited the store can acquire, by detecting the beacon using a smartphone or the like, information concerning a service that the store desires to recommend.

### CITATION LIST

### Patent Literature

Patent Literature 1: JP 2016-66290 A
Patent Literature 2: JP 2017-188904 A

### SUMMARY

### Technical Problem

In the related art, since the beacon is transmitted using the beacon transmitter, every time a commodity is replaced or a layout is changed, it is necessary to change the position of the beacon transmitter as well. This requires a lot of labor, in particular, in a large-scale store or a chain store including a plurality of stores.

In the related art, content for recommending a commodity to a customer is set according to a purchase history or an interest at the time of member registration of the customer. For that reason, in some case, it is difficult for the customer to accept the recommended content because a purpose of the customer visiting the store or a change in mood or interest while the customer is moving in the store cannot be grasped.

An object of the present disclosure is to provide an information processing device, an information processing method, and an information processing program that enable provision of appropriate content with simple work on a service providing side.

### Solution to Problem

For solving the problem described above, an information processing device according to one aspect of the present disclosure has a service management unit that manages a notification position for providing notification of provision of a service corresponding to a degree of interest of a user, the notification position being arranged with respect to map information; and a user management unit that acquires, based on the map information, a position of a user terminal identified based on identification information for identifying the user and transmits notification to the user terminal when the position of the user terminal is within a notification range of the notification position.

For solving the problem described above, an information processing device according to one aspect of the present disclosure has a detection unit that detects at least a current position in a service providing region for providing a service corresponding to a degree of interest of a user; a communication unit that performs communication via a network; and a display control unit that displays a screen on a display unit, wherein the display control unit causes the display unit to display information based on notification at a notification position corresponding to the current position in map information indicating the service providing region, the information being acquired via the network according to the position detected by the detection unit.

Also, for solving the problem described above, an information processing device according to one aspect of the present disclosure has an input control unit that performs control corresponding to user operation; a display control unit that causes a display unit to display information; and a communication unit that performs communication via a network, wherein the input control unit arranges, with respect to map information indicating a service providing region for providing a service corresponding to a degree of interest of a service recipient, according to the user operation, a notification position for providing notification of information concerning the service and transmits the map information in which the notification position is arranged to the network.

### BRIEF DESCRIPTION OF THE DRAWINGS

FIG. 1 is a schematic diagram for explaining notification of commodity information according to an existing technique.

FIG. 2 is a schematic diagram for explaining notification of commodity information according to an embodiment of the present disclosure.

FIG. 3 is a schematic diagram illustrating a configuration of an example of an information processing system according to the embodiment.

FIG. 4 is a block diagram illustrating a configuration of an example of a server applicable to the embodiment.

FIG. 5 is a block diagram illustrating a configuration of an example of a user terminal applicable to the embodiment.

FIG. 6 is a block diagram illustrating a configuration of an example of a store management terminal applicable to the embodiment.

FIG. 7 is a functional block diagram of an example for explaining functions of the server according to the embodiment.

FIG. 8 is a functional block diagram of an example for explaining functions of the user terminal according to the embodiment.

FIG. 9 is a functional block diagram of an example for explaining functions of the store side management terminal according to the embodiment.

FIG. 10 is a flowchart for explaining an overall flow of purchase processing according to the embodiment.

FIG. 11 is a sequence chart of an example for explaining preparation on a store side and a user side according to the embodiment.

FIG. 12 is a schematic diagram illustrating an example of a store map displayed on the store side management terminal.

FIG. 13 is a schematic diagram illustrating an example of a commodity correlation screen for correlating a commodity with a push position, the commodity correlation screen being displayed on the store side management terminal.

FIG. 14 is a schematic diagram illustrating an example of a degree-of-interest correlation screen for correlating content with an indicator of a degree of interest, the degree-of-interest correlation screen being displayed on the store side management terminal.

FIG. 15 is a schematic diagram illustrating an example of a map screen displayed on the store side management terminal.

FIG. 16 is a schematic diagram illustrating an example of a tour route expected for a user who has visited a store in a store map in which commodities, indicators of degrees of interest, and contents are correlated with push positions.

FIG. 17 is a schematic diagram illustrating an example of a dashboard screen displayed on the store side management terminal.

FIG. 18 is a schematic diagram illustrating an example of a flier information screen displayed on the user terminal.

FIG. 19 is a sequence chart of an example for explaining processing performed when a user whose purchase action is a predetermination type visits the store according to an embodiment.

FIG. 20 is a schematic diagram illustrating a situation in which a QR code posted at an entrance of the store is read using the user terminal according to the embodiment.

FIG. 21 is a schematic diagram illustrating an example of a store map displayed on the user terminal according to the embodiment.

FIG. 22 is a schematic diagram illustrating an example of display by the user terminal at the time when push notification is opened according to the embodiment.

FIG. 23 is a sequence chart of an example for explaining processing performed when a user whose purchase action is an in-store determination type visits the store according to the embodiment.

FIG. 24 is a schematic diagram for explaining that push notification is transmitted to a user terminal of a user present within a push range of a push position according to the embodiment.

FIG. 25 is a schematic diagram illustrating an example of content corresponding to a degree of interest according to the embodiment.

FIG. 26 is a sequence chart of an example for explaining settlement processing according to the embodiment.

FIG. 27 is a schematic diagram illustrating an example of a screen of the user terminal at the time when the user purchases a push commodity.

FIG. 28 is a schematic diagram illustrating an example of a content display screen, which displays content for promoting further purchase, according to the embodiment.

FIG. 29 is a schematic diagram illustrating an example of a store map, on which navigation information to an additionally pushed push commodity position is superimposed, according to the embodiment.

### DESCRIPTION OF EMBODIMENTS

An embodiment of the present disclosure is explained in detail below with reference to the drawings. Note that, in the embodiment explained below, redundant explanation is omitted by denoting the same parts with the same reference numerals and signs.

The embodiment of the present disclosure is explained in detail below according to the following order.
1. Summary of a technique according to the present disclosure
1-1. Existing technique
1-2. Technique according to the present disclosure
2. Embodiment
2-1. Configuration according to the embodiment
2-2. Overview of processing according to the embodiment
2-3. Details of the processing according to the embodiment
2-3-1. Preparation on a store side and a user side according to the embodiment
2-3-2. Measures taken for a predetermination type according to the embodiment
2-3-3. Measures taken for an in-store determination type according to the embodiment
2-3-4. Settlement processing according to the embodiment

### 1. Overview of a Technique According to the Present Disclosure

First, an overview of a technique according to the present disclosure is explained. The technique according to the present disclosure relates to an information processing system for providing a service in a predetermined region. The information processing system according to the present disclosure notifies, for example, services respectively provided at positions in the predetermined region to, at the positions where the services are respectively provided, easily portable information equipment such as a smartphone possessed by a user who has visited the predetermined region.

As the services in the predetermined region according to the present disclosure, for example, sales of commodities in a store may be applied. In this case, the user who has visited the store, which is the predetermined region, is a guest or a customer. In the following explanation, unless particularly described otherwise, the guest or the customer who has visited the store is referred to as user.

### (1-1. Existing Technique)

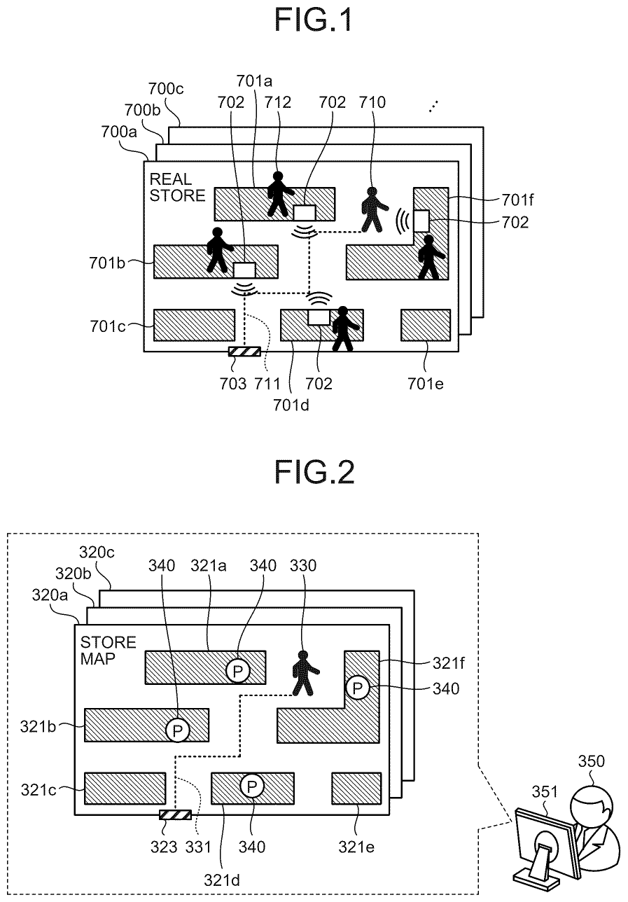

Before the embodiment of the present disclosure is explained, in order to facilitate understanding, notification of commodity information according to an existing technique is schematically described. FIG. 1 is a schematic diagram for explaining notification of commodity information according to the existing technique.

In FIG. 1, real stores 700a, 700b, 700c, . . . , which are stores in the real world, are considered. In an example illustrated in FIG. 1, for example, in the real store 700a, display shelves 701a to 701f on which, for example, commodities are displayed are disposed in the store. In the example illustrated in the figure, commodities desired to be pushed to users are displayed on the display shelves 701a, 701b, 701d, and 701f and beacon transmitters 702 that transmit beacons including commodity information are respectively disposed at positions corresponding to the commodities.

The beacons transmitted from the beacon transmitters 702 are received by, for example, a smartphone possessed by a user 710. For example, the user 710 can, by entering the inside of the real store 700a from an entrance 703 and receiving the beacons transmitted from the beacon transmitters 702, for example, trace a route 711 and go around positions of commodities that the store side desires to push.

Note that “push a commodity” means that, for example, when there is a commodity that a store desires to cause a user to purchase or desires to introduce to the user, the store side actively recommends the commodity to the user. A commodity to be pushed is referred to as push commodity. In general, the commodity is pushed using text, a still image, a moving image, or the like for introducing the push commodity. Not only this, but the commodity is sometimes pushed using a coupon that provides a discount, a benefit, or the like for the push commodity.

In the existing technique, the beacon transmitters 702 are devices configured by circuits in a real world and have physical entities. Therefore, it is necessary to prepare the beacon transmitters 702 for each of push positions, leading to an increase in cost. For example, a staff member 712 of the real store 700a disposes the beacon transmitters 702 at the push positions. This requires manpower for installation and movement of the beacon transmitters 702 and becomes a burden on the store side. Further, it is extremely difficult to change disposition positions of the beacon transmitters 702 in real time. Furthermore, in the existing technique, since the disposition positions of the beacon transmitters 702 are determined in light of experience or the like on the store side, it has been difficult to determine whether the disposition positions of the beacon transmitters 702 are appropriate.

### (1-2. Technique According to the Present Disclosure)

Subsequently, notification of commodity information by the technique according to the present disclosure is schematically explained. FIG. 2 is a schematic diagram for explaining notification of commodity information according to the embodiment of the present disclosure.

In FIG. 2, map information 320a, 320b, 320c, . . . respectively indicating layouts of stores in the real world is considered. The map information 320a, 320b, 320c, . . . is respectively information virtually indicating the layouts of the stores in the real world. In the following explanation, map information is sometimes referred to as store map.

In an example illustrated in FIG. 2, for example, information concerning display shelves 321a to 321f on which, for example, commodities are respectively displayed is arranged in the map information 320a. In the example illustrated in the figure, commodities desired to be pushed to users are displayed in display shelves of a real store corresponding to the display shelves 321a, 321b, 321d, and 321f, and push positions for pushing the commodities are arranged at positions corresponding to the commodities in the map information 320a. Respective kinds of notification information 340 for performing notification including commodity information are correlated with the push positions.

When a user 330 visits a real store corresponding to the map information 320a, for example, the user 330 may acquire the map information 320a including the push positions using a smartphone serving as a user terminal possessed by the user 330. An optimum route 331 for going around the push positions may be superimposed on the map information 320a. For example, the user 330 can, for example, by entering the inside of the real store 700a shown in the map information 320a from an entrance 323 and referring to the push positions and a route 331, trace the route 331 and go around positions of commodities that the store side desires to push.

As explained above, according to the technique of the present disclosure, it is unnecessary to prepare the beacon transmitters 702. Therefore, it is possible to suppress cost compared with the existing technique. According to the technique of the present disclosure, for example, an administrator 350 or the like, who manages the stores, is capable of collectively managing and changing push positions of the map information 320a, 320c, . . . and the notification information 340 correlated with the push positions using a terminal device 351, for example, from a remote place from the real store indicated by the map information 320a. Therefore, it is possible to greatly suppress labor required for changing push information compared with the existing technique. Since the notification information 340 correlated with the push positions is present as data and does not have a physical entity, it is easy to change arrangement positions, contents, and the like of the respective kinds of notification information 340 in real time.

Further, by using identification information for identifying the user terminal possessed by the user 330, it is possible to collect and manage, for each user, purchase data such as a purchase history of commodities. Consequently, according to the technique of the present disclosure, it is possible to optimize, for each user 330, push positions and contents notified at the push positions.

### 2. Embodiment

Subsequently, the embodiment of the present disclosure is explained more in detail.

### (2-1. Configuration According to the Embodiment)

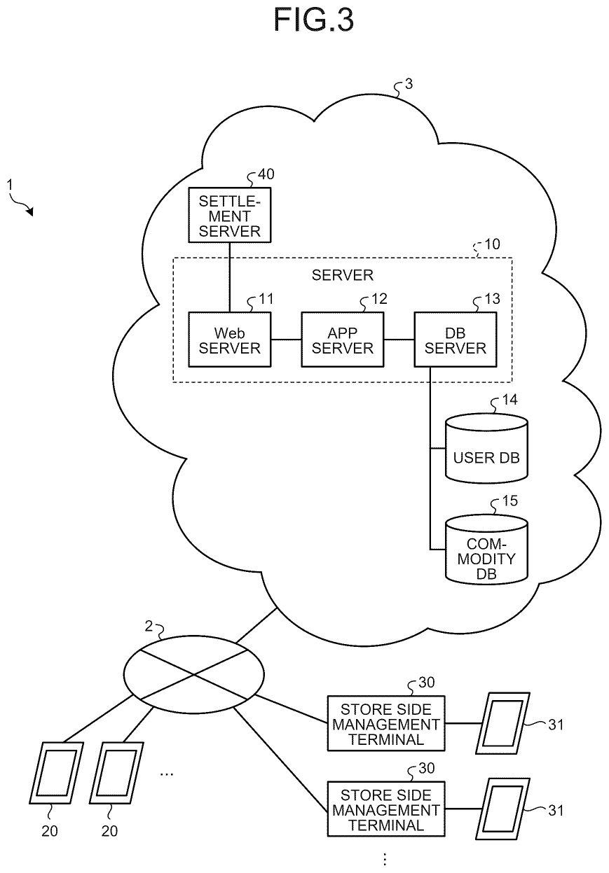

First, a configuration according to the embodiment is explained. FIG. 3 is a schematic diagram illustrating a configuration of an example of an information processing system according to the embodiment.

In FIG. 3, an information processing system 1 according to the embodiment includes a server 10, a user terminal 20, and a store side management terminal 30 communicably connected to one another via the Internet 2. In the example illustrated in FIG. 3, the server 10 is configured on a cloud network 3 connected to the Internet 2. The cloud network 3 is a network that includes pluralities of computers and storage devices communicably connected to one another via a network and makes it possible to provide computer resources in a form of a service.

The server 10 includes a Web server 11, an application server 12 (described as APP server 12 in the figure), and database (DB) server 13. The server 10 may be configured by an independent computer or may be configured using computer resources such as pluralities of computers and storage devices on the cloud network 3 in a distributed manner.

In the server 10, the Web server 11 provides a service using the Internet 2 to clients (the user terminal 20, the store side management terminal 30, and the like) based on a HTTP (Hypertext Transfer Protocol). The APP server 12 provides functions of applications in the information processing system 1. For example, the APP server 12 provides functions such as a position server function for acquiring position information indicating the position of the user terminal 20, a map server function for matching the position information with map information of a store, and a push server for performing notification by notification information.

A user DB 14 and a commodity DB 15 are connected to the DB server 13. The DB server 13 provides database management functions such as data registration and search processing for the user DB 14 and the commodity DB 15.

Note that a settlement server 40 is included in, for example, a system outside the information processing system 1 and executes settlement processing according to, for example, settlement information transmitted from the Web server 11.

The user terminal 20 is easily portable information equipment and is, for example, a smartphone. A tablet computer may be applied as the user terminal 20. The user terminal 20 according to the embodiment includes a geomagnetic sensor and an atmospheric pressure sensor as means for position measurement for measuring the position of the user terminal 20. The user terminal 20 includes, for example, a 6-axis or 9-axis gyro as means for acquiring the posture of the user terminal 20. Further, the user terminal 20 includes a camera for imaging a bar code attached to a commodity and a QR (Quick Response) code (registered trademark) for registering, in the store, entrance to the store.

For example, a general personal computer can be applied to the store side management terminal 30. The store side management terminal 30 performs, according to operation of a staff member of the store, setting such as arrangement of notification information with respect to the store map and management of purchase information of commodities performed using the user terminal 20. Note that a store side terminal 31 is, for example, a smartphone and includes a geomagnetic sensor and an atmospheric pressure sensor as means for position measurement for measuring the position of the store side terminal 31. For example, a staff member of the store can go around the store and create a rough map of the store based on detection results of the geomagnetic sensor and the atmospheric pressure sensor using the store side terminal 31. By integrating this map and layout information of display shelves and the like in the store, it is possible to create the map information as illustrated in FIG. 2.

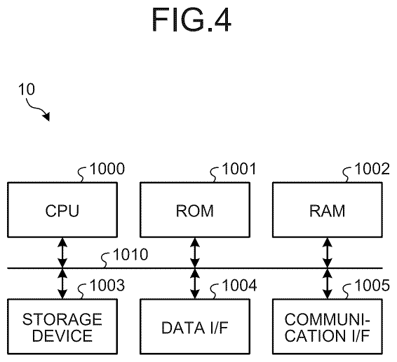

FIG. 4 is a block diagram illustrating a configuration of an example of the server 10 applicable to the embodiment. Note that, in the example illustrated in FIG. 4, for explanation, the server 10 is illustrated as being configured by a single computer.

In FIG. 4, the server 10 includes a CPU (Central Processing Unit) 1000, a ROM (Read Only Memory) 1001, a RAM (Random Access Memory) 1002, a storage device 1003, a data I/F 1004, and a communication I/F 1005 which are communicably connected to one another via a bus 1010. The storage device 1003 is a nonvolatile storage

medium such as a hard disk drive or a flash memory. The CPU 1000 controls an entire operation of the server 10 using the RAM 1002 as a work memory according to a program stored in the storage device 1003 or the ROM 1001.

The data I/F (interface) 1004 is an interface for transmitting and receiving data to and from an external device. The communication I/F 1005 is an interface for performing communication in the cloud network 3 and communication via the Internet 2.

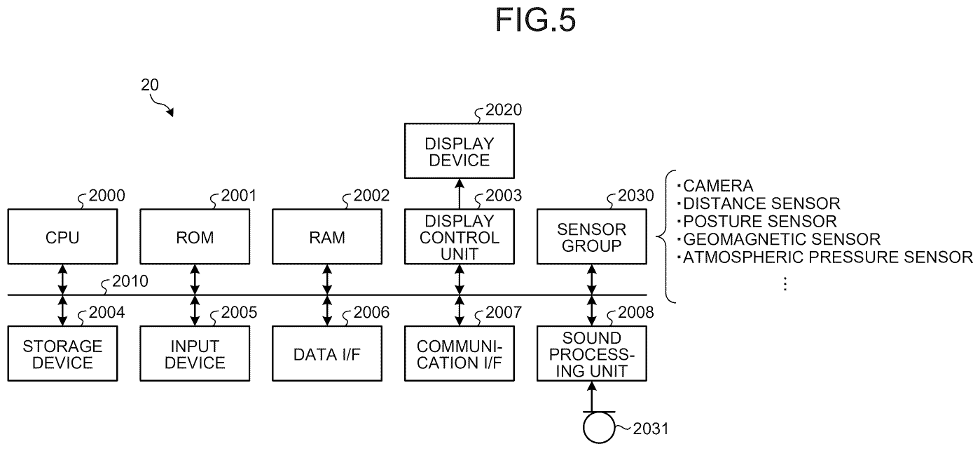

FIG. 5 is a block diagram illustrating a configuration of an example of the user terminal 20 applicable to the embodiment.

In FIG. 5, the user terminal 20 includes a CPU 2000, a ROM 2001, a RAM 2002, a display control unit 2003, a storage device 2004, an input device 2005, a data I/F 2006, a communication I/F 2007, and a sound processing unit 2008 communicably connected to one another by a bus 2010.

The storage device 2004 is a nonvolatile storage medium such as a hard disk drive or a flash memory. The CPU 2000 controls an entire operation of the user terminal 20 using the RAM 2002 as a work memory according to a program stored in the ROM 2001 or the storage device 2004.

The display control unit 2003 generates, based on display control information delivered by the CPU 2000, a display signal that can be handled by a display device 2020. The display device 2020 includes, for example, a display element such as an LCD (Liquid Crystal Display) and a drive circuit that drives the display element. The display device 2020 displays a screen based on the display control information with the display element according to a display signal delivered from the display control unit 2003. Note that, in the following explanation, a screen being displayed on the display device 2020 of the user terminal 20 is described as, for example, a screen being displayed on the user terminal 20.

For example, a touch pad that outputs a control signal corresponding to a position touched by user operation may be applied to the input device 2005. The input device 2005 and the display device 2020 may be integrally formed such that the input device 2005 is capable of transmitting the display by the display device 2020 and configure a so-called touch panel.

The data I/F 2006 is an interface for transmitting and receiving data to and from external equipment. The communication I/F 2007 is, for example, an interface for connecting to the Internet 2 by wireless communication. A microphone 2031 is connected to the sound processing unit 2008. The sound processing unit 2008 executes signal processing for a sound signal based on collected sound output from the microphone 2031. For example, the sound processing unit 2008 may convert a sound signal output from the microphone 2031 in an analog format according to sound collection into digital sound data and output the digital sound data.

In the user terminal 20, a sensor group 2030 is connected to the bus 2010. The sensor group 2030 includes, for example, various sensors such as a camera, a distance sensor, a posture sensor, a geomagnetic sensor, and an atmospheric pressure sensor and an interface for connecting the sensors and the bus 2010.

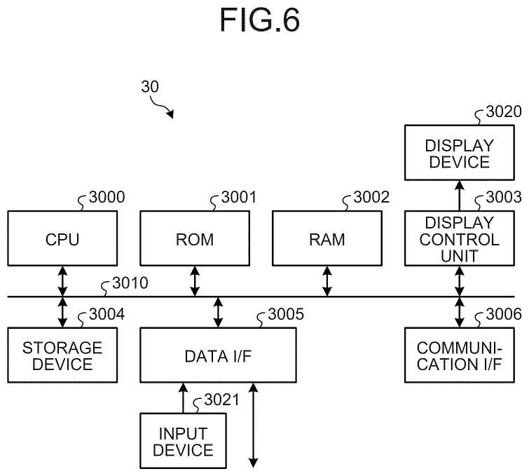

FIG. 6 is a block diagram illustrating a configuration of an example of the store side management terminal 30 applicable to the embodiment.

In FIG. 6, the store side management terminal 30 includes a CPU 3000, a ROM 3001, a RAM 3002, a display control unit 3003, a storage device 3004, a data I/F 3005, and a communication I/F 3006 communicably connected to one another by a bus 3010.

The storage device 3004 is a nonvolatile storage medium such as a hard disk drive or a flash memory. The CPU 3000 controls an overall operation of the store side management terminal 30 using the RAM 3002 as a work memory according to a program stored in the ROM 3001 or the storage device 3004.

The display control unit 3003 generates, based on display control information delivered by the CPU 3000, a display signal that can be handled by a display device 3020. The display device 3020 includes, for example, a display element such as an LCD and a drive circuit that drives the display element. The display device 3020 displays, according to the display signal delivered from the display control unit 3003, a screen based on the display control information with the display element. Note that, in the following explanation, a screen being displayed on the display device 3020 of the store side management terminal 30 is described as, for example, a screen being displayed on the store side management terminal 30.

The data I/F 3005 is an interface for transmitting and receiving data to and from external equipment. In the example illustrated in FIG. 6, an input device 3021 for receiving user operation is connected to the data I/F 3005. The input device 3021 may include a pointing device such as a mouse or a touch pad and a keyboard. The input device 3021 outputs a control signal corresponding to user operation. The control signal output from the input device 3021 is delivered to the CPU 3000 via the data I/F 3005.

The communication I/F 3006 is, for example, an interface for connecting to the Internet 2 by wireless communication or wired communication.

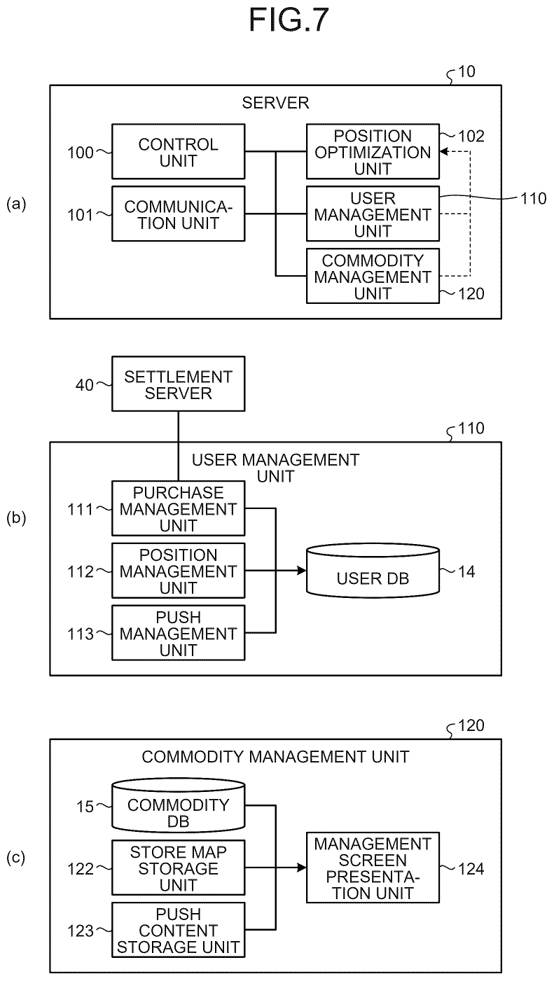

FIG. 7 is a functional block diagram of an example for explaining the functions of the server 10 according to the embodiment. In FIG. 7, as illustrated in a section (a), the server 10 includes a control unit 100, a communication unit 101, a position optimization unit 102, a user management unit 110, and a commodity management unit 120.

The control unit 100, the communication unit 101, the position optimization unit 102, the user management unit 110, and the commodity management unit 120 are implemented by an information processing program for the server 10 according to the embodiment operating on the CPU 1000. Not only this, but a part or all of the control unit 100, the communication unit 101, the position optimization unit 102, the user management unit 110, and the commodity management unit 120 may be implemented by hardware circuits that operate in cooperation with one another.

The control unit 100 controls basic operations of the units of the server 10. The communication unit 101 controls communication by the communication I/F 1005. The position optimization unit 102 optimizes, based on information delivered from the user management unit 110 and the commodity management unit 120, for example, the push position (the notification position) explained with reference to FIG. 2. The user management unit 110 manages information acquired from the user terminal 20. The commodity management unit 120 manages information set in the store side management terminal 30 and information concerning commodities to be sold in the store.

In FIG. 7, a section (b) illustrates a functional block diagram of an example for explaining the functions of the user management unit 110 illustrated in the section (a) of the figure. The user management unit 110 includes a purchase management unit 111, a position management unit 112, a push management unit 113, and a user DB 14.

The purchase management unit 111 manages information concerning purchase of a commodity acquired from the user terminal 20. The purchase management unit 111 acquires, for example, from the user terminal 20, a user ID serving as identification information for identifying a user who uses the user terminal 20. The purchase management unit 111 may acquire, from the user terminal 20, purchase information indicating that the user has read a barcode of a commodity and purchased the commodity and manage the purchase information as a purchase history. The purchase management unit 111 manages the purchase history in correlation with the user ID. The purchase management unit 111 transmits the purchase information to the settlement server 40 and requests the settlement server 40 to make settlement. A settlement result by the settlement server 40 is returned to the purchase management unit 111. The purchase management unit 111 may include settlement information returned from the settlement server 40 in the purchase history corresponding to the settlement information and manage the settlement information.

The position management unit 112 manages position information indicating the position of the user terminal 20 and posture information indicating the posture of the user terminal 20 acquired from the user terminal 20 in correlation with the user ID. The position management unit 112 may manage the position information and the posture information as an action history of the user having the user ID. The position management unit 112 may acquire, based on the position information and the posture information, in which position the user having the user ID has stayed, which direction the user has faced, and for how long the user has stayed. The position management unit 112 may acquire a degree of interest of the user in a commodity or the like at a stay position based on the direction and the stay time of the user.

The push management unit 113 manages information (push information) concerning a reaction to the notification information of the push position (see FIG. 2) acquired from the user terminal 20. For example, the push management unit 113 acquires push information based on a stay time and a direction of the user within a notification range of notification information at a push position, purchase information corresponding to the notification information at the push position, and the like.

The purchase information or the purchase history acquired by the purchase management unit 111, a degree of interest in a specific commodity or the like acquired by the position management unit 112, and the push information acquired by the push management unit 113 are stored in the user DB 14 in correlation with the user ID corresponding thereto.

As explained above, the user management unit 110 functions as a user management unit that acquires, based on the map information, the position of a user terminal identified based on identification information for identifying a user and transmits notification to the user terminal when the position of the user terminal is within a notification range of a notification position.

In FIG. 7, a section (c) illustrates a functional block diagram of an example for explaining the functions of the commodity management unit 120 illustrated in the section (a) of the figure. The commodity management unit 120 includes a commodity DB 15, a store map storage unit 122, a push content storage unit 123, and a management screen presentation unit 124.

The commodity DB 15 stores information on commodities displayed in the store. The commodity information included in the commodity DB 15 may include names, categories, prices, identification information, stock quantities, store information, and the like of the commodities. The commodity DB 15 may correlate, with commodity information of a certain commodity, information concerning another commodity relating to the commodity. The other commodity relating to the certain commodity may be a commodity, a category or the like of which is common or approximate to a category of the certain commodity. The other commodity relating to the certain commodity may be a commodity that a user who has purchased the certain commodity often purchases together with the certain commodity.

The store map storage unit 122 stores map information (store maps) of stores relating to the information processing system 1. The store maps may include layout information in the stores and information indicating push positions for pushing commodities. The store maps may include, for example, information concerning commodities displayed on display shelves disposed in the stores.

The push content storage unit 123 stores, in correlation with each other, information indicating commodities to be pushed and a position in a store where the push is performed. The push content storage unit 123 stores, in correlation with each other, for each of the commodities to be pushed, an indicator indicating a degree of interest and content used for the push. For example, the push content storage unit 123 may correlate, with the commodities to be pushed, different content for each indicator indicating the degree of interest.

The management screen presentation unit 124 generates, based on the respective kinds of information stored in the commodity DB 15, the store map storage unit 122, and the push content storage unit 123, a management screen to be displayed on the store side management terminal 30 and transmits the generated management screen to the store side management terminal 30. The store side management terminal 30 can manage and edit, using this management screen, the respective kinds of information stored in the commodity DB 15, the store map storage unit 122, and the push content storage unit 123.

As explained above, the commodity management unit 120 functions as a service management unit that manages a notification position arranged for the map information for providing notification of provision of a service corresponding to a degree of interest of the user.

In the server 10, an information processing program for a server according to the embodiment is executed, whereby the CPU 1000 configures the position optimization unit 102, the user management unit 110, and the commodity management unit 120 explained above on a main storage region in the RAM 1002 respectively as, for example, modules.

The information processing program can be acquired from the outside via, for example, the Internet 2 by communication via the communication I/F 1005 and installed on the server 10. Not only this, but the program may be provided while being stored in a detachable storage medium such as a CD (Compact Disk), a DVD (Digital Versatile Disk), or a USB (Universal Serial Bus) memory.

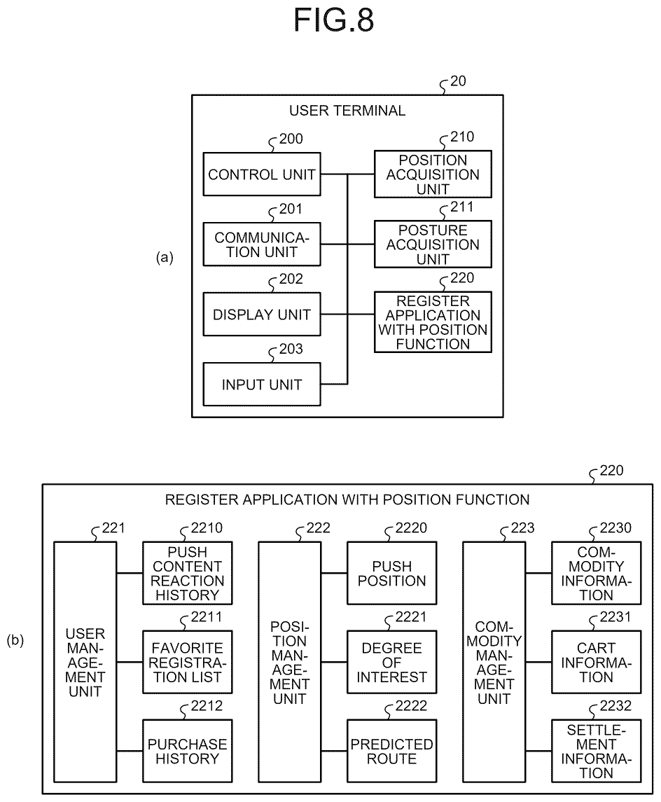

FIG. 8 is a functional block diagram of an example for explaining functions of the user terminal 20 according to the embodiment.

In FIG. 8, as illustrated in a section (a), the user terminal 20 includes a control unit 200, a communication unit 201, a display unit 202, an input unit 203, a position acquisition unit 210, a posture acquisition unit 211, and a register application with position function 220.

The control unit 200, the communication unit 201, the display unit 202, the input unit 203, the position acquisition unit 210, the posture acquisition unit 211, and the register application with position function 220 are implemented by an information processing program for the user terminal 20 according to the embodiment operating in the CPU 2000. Not only this, but a part or all of the control unit 200, the communication unit 201, the display unit 202, the input unit 203, the position acquisition unit 210, the posture acquisition unit 211, and the register application with position function 220 may be implemented by hardware circuits that operate in cooperation with one another.

The control unit 200 is, for example, an OS (Operating System) and controls basic operations of the units of the user terminal 20. The communication unit 201 controls communication by the communication I/F 2007. The display unit 202 generates display control information and controls screen display on the display device 2020. The input unit 203 receives user operation on the input device 2005 and generates a control signal corresponding to the user operation.

The position acquisition unit 210 acquires position information indicating a current position of the user terminal 20 based on outputs of the geomagnetic sensor and the atmospheric pressure sensor included in the sensor group 2030. The posture acquisition unit 211 acquires, based on output of the posture sensor included in the sensor group 2030, posture information indicating the posture of the user terminal 20.

Note that the control unit 200, the communication unit 201, the display unit 202, the input unit 203, the position acquisition unit 210, and the posture acquisition unit 211 may be functions installed in the user terminal 20 in advance.

The register application with position function 220 is implemented by an application program (an information processing program for information for the user terminal 20), which realizes the functions according to the embodiment in the user terminal 20, operating on the CPU 2000. The register application with position function 220 acquires and manages information concerning an action of the user who uses the user terminal 20 and user operation on the user terminal 20, information concerning the position of the user terminal 20 such as a current position and a direction of the user terminal 20, and information concerning commodity purchase by the user.

In FIG. 8, a section (b) illustrates a functional block diagram of an example for explaining the functions of the register application with position function 220 illustrated in the section (a) of the figure. The register application with position function 220 includes a user management unit 221, a position management unit 222, and a commodity management unit 223.

The user management unit 221 manages, for example, a push content reaction history 2210, a favorite registration list 2211, and a purchase history 2212.

The push content reaction history 2210 is a history of the user having reacted to push content presented to the user terminal 20. The push content is content concerning a commodity to be pushed (for example, introduction of a push commodity). Text data, moving image data, still image data, sound data, or the like is used as the push content. The push content is included in, for example, notification information correlated with a push position and notified.

The favorite registration list 2211 is generated by selecting and registering, for example, from a list of push commodities transmitted to the user terminal 20 beforehand, with user operation on the user terminal 20, a commodity that the user is interested in or desires to purchase. The purchase history 2212 is a history of the user having purchased commodities using the user terminal 20 in the store.

The push content reaction history 2210, the favorite registration list 2211, and the purchase history 2212 are obtained by encrypting information retained in the server 10 and mirroring the information to the user terminal 20. The user can browse these kinds of information offline on the user terminal 20.

The position management unit 222 manages, for example, a push position 2220, a degree of interest 2221, and a predicted route 2222.

The push position 2220 includes, for example, a store map, and indicates position information indicating a position where a commodity is pushed on the store map. The degree of interest 2221 is a degree of interest in a push commodity or the like calculated based on a stay time based on the current position of the user terminal 20 acquired by the position acquisition unit 210 and a direction of the user terminal 20 based on the posture information acquired by the posture acquisition unit 211. The predicted route 2222 is a route at the time when the user of the user terminal 20 tours around the store, the predicted route 2222 being predicted based on, for example, the push position 2220.

The commodity management unit 223 manages commodity information 2230, cart information 2231, and settlement information 2232.

The commodity information 2230 is information obtained by scanning, using a camera function of the user terminal 20, a barcode displayed on a commodity to be purchased. The cart information 2231 is information indicating whether the commodity, the barcode of which has been scanned, has been put in a cart. The cart information 2231 may be a list of commodities currently put in the cart. The settlement information 2232 is settlement information concerning the commodity put in the cart. The settlement information may correspond to information transmitted from the purchase management unit 111 to the settlement server 40 in the server 10 and include, for example, identification information of a settled commodity, a settlement price, a settlement method, and a settlement date and time.

The user management unit 221, the position management unit 222, and the commodity management unit 223 included in the register application with position function 220 correspond to the functions included in the user management unit 110 and the commodity management unit 120 of the server 10. As explained above, the functions included in the server 10 are imparted to the user terminal 20 as well. Therefore, the user is enabled to execute, for example, check of notification information correlated with a push position even if the user terminal 20 is offline to the server 10.

For example, the push position 2220, the degree of interest 2221, and the predicted route 2222 may be retained by the server 10. However, by keeping these kinds of information on the user terminal 20 side, it is possible to increase response of processing. For example, the degree of interest 2221 may be calculated offline in the user terminal 20. Since the user is moving, if it takes time for calculation processing for the degree of interest 2221, the user may pass a push position. For that reason, it is preferable to calculate the degree of interest 2221 offline. The degree of interest 2221 may be calculated in the register application with position function 220.

In the user terminal 20, an information processing program for the user terminal according to the embodiment is executed, whereby the CPU 2000 configures, on a main storage region of the RAM 2002, respectively as, for example, modules, the user management unit 221, the position management unit 222, and the commodity management unit 223 included in the register application with position function 220 explained above.

The information processing program can be acquired from the outside via, for example, the Internet 2 by communication via a communication I/F 3007 and installed on the user terminal 20. Not only this, but the program may be provided by being stored in a detachable storage medium such as a CD (Compact Disk), a DVD (Digital Versatile Disk), or a USB (Universal Serial Bus) memory or may be provided from external equipment via the data I/F 2006.

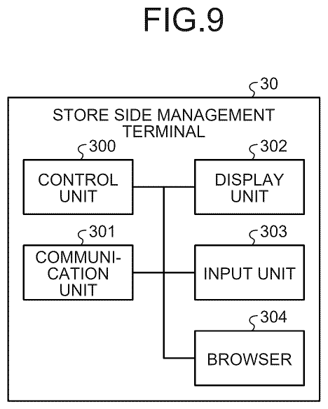

FIG. 9 is a functional block diagram of an example for explaining the functions of the store side management terminal 30 according to the embodiment.

As illustrated in FIG. 9, the store side management terminal 30 includes a control unit 300, a communication unit 301, a display unit 302, an input unit 303, and a browser application 304 (described as browser 304 in FIG. 9).

The control unit 300, the communication unit 301, the display unit 302, the input unit 303, and the browser application 304 are implemented by an information processing program for the store side management terminal 30 according to the embodiment operating in the CPU 3000. Not only this, but a part or all of the control unit 300, the communication unit 301, the display unit 302, the input unit 303, and the browser application 304 may be implemented by hardware circuits that operate in cooperation with one another.

The control unit 300 is, for example, an OS and controls basic operations of the units of the store side management terminal 30. The communication unit 301 controls communication by the communication I/F 3006. The display unit 302 generates display control information and controls screen display on the display device 3020. The input unit 303 receives user operation on the input device 3021 and generates a control signal corresponding to user operation.

The browser application 304 can read, for example, an HTML file described using the hypertext markup language (HTML) on the Internet 2 and execute generation of a display control signal, input control, communication control, and the like according to the description in the file. For example, the browser application 304 can, by reading, for example, a Web application on the Internet 2, cause the store side management terminal 30 to implement functions by the Web application. For example, the Web application (referred to as store side terminal application) for implementing the functions in the store side management terminal 30 according to the embodiment may be provided by the Web server 11 included in the server 10.

The browser application 304 reads the store side terminal application from the server 10 and causes the display device 3020 to display, for example, a management screen presented by the management screen presentation unit 124 in the server 10. The browser application 304 generates, according to the store side terminal application, information corresponding to user operation performed according to the management screen. The browser application 304 transmits information generated by the store side terminal application to the server 10 according to necessity.

Note that, in the above explanation, it is explained that the store side terminal application for implementing the functions of the store side management terminal 30 according to the embodiment is the Web application acquired from the server 10. However, this is not limited to this example. For example, the store side terminal application may be a dedicated application program individually installed on the store side management terminal 30.

### (2-2. Overview of Processing According to the Embodiment)

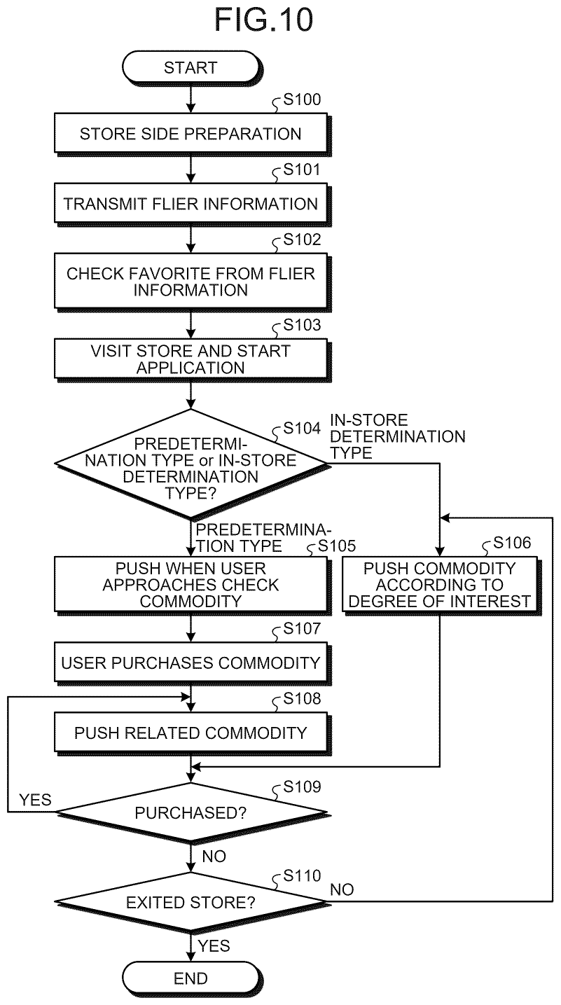

Subsequently, processing according to the embodiment will be schematically explained. FIG. 10 is a flowchart of an example for explaining an overall flow of purchase processing according to the embodiment.

Here, explanation is made assuming that a user A goes to a store B and purchases a commodity in the store B with a self-service POS (Point Of Sales) register function using, as the user terminal 20, a smartphone possessed by the user A. As an example, the user A scans a barcode printed or pasted on a commodity using the camera function of the user terminal 20 and puts the commodity in a virtual cart. Alternatively, when a commodity to be purchased by the user A is a push commodity corresponding to push notification explained below and the push notification includes information corresponding to a barcode, the user A can omit scanning of the barcode and put the commodity in the virtual cart.

The user A puts an actual commodity to be purchased in, for example, a shopping basket in the real world simultaneously with putting the commodity in the virtual cart.

Note that the virtual cart stores information indicating a commodity as a purchase planned commodity. For example, the virtual cart can be configured as a region correlated with the user in the user DB 14. The information concerning the commodity stored in the virtual cart may include attribute information such as a name, a commodity category, and a price of the commodity together with the identification information of the commodity. By viewing the virtual cart, the user A can check, as a list, information concerning commodities selected as purchase planned commodities by the user A.

For example, the purchase of a series of commodities is completed, the user A performs, from the user terminal 20, settlement of the commodities put in the virtual cart. The settlement is performed using, for example, information such as a credit card registered in advance in the settlement server 40. As explained above, by using a self-service POS register function, the user A is capable of executing the settlement of the commodities selected by the user A with hands of the user A. When the settlement is completed, the user A is capable of bringing back the purchased commodities.

In FIG. 10, in Step S100, preparation for commodity sales is performed in the store B. For example, in the store B, the store side management terminal 30 creates a store map of the store B using layout information of the store B and position information acquired using the store side terminal 31 and arranges, on the created store map, a push position where a commodity is pushed. For example, notification information for prompting purchase of the commodity is correlated with the push position. The notification information may include content (text data, moving image data, still image data, and the like) for prompting the purchase of the push commodity.

The store side management terminal 30 transmits, to the server 10, the store map on which the push position is arranged and the notification information corresponding to the push position. The server 10 stores the store map transmitted from the store side management terminal 30 in the store map storage unit 122. The server 10 stores the notification information transmitted from the store side management terminal 30 in the push content storage unit 123.

Further, in the store B, for example, the store side management terminal 30 is used to create flier information on which the information concerning the push commodity is posted.

In the next Step S101, the store B transmits the created flier information to the Internet 2 with the store side management terminal 30. It is assumed that the transmitted flier information is received by the user terminal 20 used by the user A.

In the next Step S102, the user A checks “favorite” with respect to the flier information received by the user terminal 20 using the register application with position function 220. For example, the user A may check, as “favorite”, a commodity planned to be purchased or a commodity that the user is interested in among commodities posted on the flier information. A list of the commodities checked as “favorite” indicates a fixed interest of the user A.

The user A visits the store B and starts the register application with position function 220 on the user terminal 20 (Step S103).

For example, the store B posts, at a store entrance, identification information, for example, a QR code, for making it possible to purchase a commodity using the register application with position function 220 in the user terminal 20. When visiting the store B, the user A reads the QR code using the camera function of the user terminal 20. The user terminal 20 starts the register application with position function 220 based on the read QR code and transmits a user ID, which is identification information, for identifying the user A to the server 10.

The server 10 authenticates the user A based on the user ID transmitted from the user terminal 20 and transmits authentication information indicating that the server 10 has succeeded in the authentication to the user terminal 20. The server 10 retains the user ID of the successfully authenticated user A and the user terminal 20 that has transmitted the user ID in, for example, the user DB 14 in correlation with each other. As an example, the server 10 may retain identification information (for example, a MAC address: Media Access Control address) of the user terminal 20 that can be acquired by communication with the user terminal 20 and the user ID in correlation with each other. The server 10 is capable of identifying the user terminal 20 based on the user ID by retaining the user ID and the user terminal 20 that has transmitted the user ID in correlation with each other. The server 10 transmits the store map of the store B to the user terminal 20. The server 10 may further transmit notification information correlated with push positions arranged on the store map to the user terminal 20.

When receiving information such as the authentication information transmitted from the server 10, the user terminal 20 may transmit, for example, flier information including check information for “favorite” to the server 10.

Note that the processing in Step S102 explained above is executed by the user A according to necessity and is not essential processing. That is, the user A may decide, beforehand, a commodity planned to be purchased and visit the store B or may determine a purchase commodity in the store B without determining a commodity beforehand.

In the following explanation, as a pattern of a purchase action by a user, a purchase action of visiting the store after determining a commodity or the like to be purchased beforehand is referred to as “predetermination type” and a purchase action of determining a purchase commodity after visiting the store without determining a commodity beforehand is referred to as “in-store determination type”.

The subsequent processing branches according to whether a purchase action of the user A who has visited the store B is the predetermination type or the in-store determination type (Step S104).

For example, the server 10 may surmise that the purchase action of the user A is the predetermination type if one or more “favorites” are checked in the flier information transmitted from the user terminal 20 and may surmise that the purchase action of the user A is the in-store determination type if no “favorite” is checked. Not only this, but the server 10 may acquire an action history of the user A in the store B and may surmise that the purchase action of the user A is the in-store determination type when, even if “favorite” is checked in the flier information, the user A does not move to a commodity position of the checked “favorite” and looks at another commodity.

The user terminal 20 may surmise, in the same manner as explained above, based on the flier information and the behavior history of the user A in the store B, whether the purchase action of the user A is the predetermination type or the in-store determination type.

When it is surmised that the purchase action of the user A is the predetermination type (Step S104, “predetermination type”), the processing shifts to Step S105. In Step S105, the server 10 determines, based on the information indicating the position and the direction transmitted from the user terminal 20 and the store map of the store B, whether the user A has approached a commodity checked as “favorite”. When the user A has approached the commodity, for example, when determining that the user has entered a notification range of notification information at a push position arranged according to the commodity, the server 10 transmits the notification information to the user terminal 20 and pushes the commodity.

Note that, in Step S105, the server 10 can transmit the store map of the store B, on which a route to a display position of the commodity checked as “favorite” is superimposed, to the user terminal 20 of the user A and cause the user terminal 20 to display the store map. This makes it possible to navigate the user A to the position of the checked commodity.

It is assumed that the user A has purchased the commodity pushed in Step S105 explained above (Step S107). That is, the user A operates the user terminal 20 to open content included in the notification information transmitted to the user terminal 20 and check details of the content. The user A can use the checked details of the content as reference information in purchasing the commodity.

Note that the purchase referred to herein indicates a motion of scanning a barcode of a commodity using the camera function of the user terminal 20 and putting the commodity in the virtual cart. Not only this, but, in Step S107, settlement may be executed for the commodity. The user terminal 20 transmits purchase information indicating that the commodity has been purchased to the server 10. The server 10 stores the commodity in the virtual cart according to the purchase information transmitted from the user terminal 20.

In the next Step S108, the server 10 pushes a related commodity related to the commodity purchased in Step S107 to the user A based on the purchase information transmitted from the user terminal 20. For example, the server 10 transmits notification information concerning a related commodity correlated with the commodity purchased in Step S107 to the user terminal 20. The user terminal 20 causes the display device 2020 to display indication based on the notification information concerning the related commodity transmitted from the server.

The user A operates the user terminal 20 in Step S108 to open the content included in the notification information concerning the related commodity transmitted to the user terminal 20 and checks the details of the content. The user A can use the checked details of the content as reference information in purchasing the related commodity.

When another commodity relating to the commodity purchased in Step S107 is pushed in Step S108, the processing is shifted to Step S109.

On the other hand, when it is determined in Step S104 that the purchase action of the user A is the in-store determination type (Step S104, “in-store determination type”), the processing is shifted to Step S106.

Note that the server 10 can transmit the store map of the store B, on which information (an icon or the like) indicating a push position corresponding to a push commodity is superimposed, to the user terminal 20 of the user A whose purchase action is “in-store determination type” and cause the user terminal 20 to display the store map. This makes it possible to navigate the user A to a route to a commodity that the store B desires to push.

In Step S106, the server 10 calculates a degree of interest in the commodity of the user A based on the information indicating the position and the direction transmitted from the user terminal 20 and the store map of the store B and pushes the commodity to the user A according to the calculated degree of interest.

For example, based on the information indicating the position transmitted from the user terminal 20, the server 10 acquires information concerning a commodity displayed in the store B to correspond to the current position of the user A and acquires a stay time Tr in which the user A stays at the position. The stay time Tr is not limited to a time in which the user A stays at the position and may include a time in the case in which the user A is moving at the position at speed equal to or lower than predetermined speed. The server 10 determines, based on the information indicating the direction transmitted from the user terminal 20, whether the user A is facing the direction of the commodity.

For example, when the user A faces the direction of the commodity for a predetermined and stays for the predetermined stay time Tr or more in the vicinity of a specific commodity, the server 10 may determine that the user A is interested in the commodity. In this case, the server 10 converts the stay time Tr into a degree of interest in the commodity by the user A. The server 10 transmits notification information correlated with the commodity to the user terminal 20 according to, for example, the degree of interest and pushes the commodity to the user A.

Note that processing of converting the stay time Tr into the degree of interest may be performed in the user terminal 20. The user terminal 20 transmits the degree of interest obtained by converting the stay time Tr to the server 10. The processing for converting the degree of interest is preferably executed in the user terminal 20 because a delay of push with respect to an action of the user A can be suppressed. The degree of interest is considered to be a value corresponding to the stay time Tr in the store of the user and indicate temporal monitoring for the commodity by the user.

The user A operates the user terminal 20 in Step S106 to open the content included in the notification information transmitted to the user terminal 20 and checks the details of the content. The user A can use the checked details of the content as reference information in purchasing the commodity.

When the commodity is pushed in Step S106, the processing is shifted to Step S109.

In Step S109, the server 10 determines whether the user A has purchased the commodity pushed in Step S108 or Step S106 (has put the commodity in the virtual cart). When determining that the user A has purchased the commodity (Step S109, “Yes”), the server 10 returns the processing to Step S108 and further pushes another commodity relating to the purchased commodity to the user A.

On the other hand, when determining in Step S109 that the user A has not purchased the commodity pushed in Step S108 or Step S106 (Step S109, “No”), the server 10 shifts the processing to Step S110.

In Step S110, the server 10 determines, based on, for example, the position information indicating the current position transmitted from the user terminal 20 of the user A, whether the user A has exited the store B. When determining that the user A has exited the store B (Step S110, “Yes”), the server 10 ends a series of processing by the flowchart of FIG. 10. Note that the user A executes settlement for the commodity put in the virtual cart before exiting the store B.

On the other hand, determining in Step S110 that the user A has not exited the store B (Step S110, “No”), for example, when it is surmised, based on the position information transmitted from the user terminal 20, that the user A is further touring in the store B, the server 10 returns the processing to, for example, Step S106.

In the flowchart of FIG. 10, based on a content opening rate at which the content included in the notification information is opened in Step S105, Step S106, and Step S108 and the details of the content, the server 10 can calculate a push reaction rate to the commodity push by the notification information. The server 10 can calculate, based on, for example, whether the user has moved to a position where the related commodity pushed in Step S108 is displayed, a customer sending rate indicating effectiveness of navigation.

Further, the server 10 can calculate, based on information concerning push commodities put in the virtual cart, a rate of the push commodities being put in the virtual cart according to notification information (referred to as put-in basket rate) and calculate, based on purchase histories of users, a rate of the push commodities being purchased according to notification information (a purchase rate).

The server 10 can dynamically change and optimize the arrangement for the push commodities in the store B and the content included in the notification information relating to the push of the commodity based on the content opening rate, the push reaction rate, the customer sending rate, the put-in basket rate, the purchase rate, and the like calculated as explained above.

The server 10 can generate, with the management screen presentation unit 124, a management screen indicating the content opening rate, the push reaction rate, the customer sending rate, the put-in basket rate, and the purchase rate and transmit the management screen to the store side management terminal 30. For example, a staff member of the store B is capable of dynamically changing the arrangement for the push commodities in the store B and the content included in the notification information relating to the push of the commodity referring to the management screen displayed on the store side management terminal 30 and transmitted from the server 10.

As explained above, in the embodiment, a PDCL (Plan-Do-Check-Learn-Plan) cycle can be rotated by a loop of Step S104 to Step S110 of the flowchart of FIG. 10. It is possible to dynamically change and optimize the push position relating to the push of the commodity and the content included in the notification information.

### (2-3. Details of the Processing According to the Embodiment)

Subsequently, the processing according to the embodiment is explained more in detail.

### (2-3-1. Preparation on the Store Side and the User Side According to the Embodiment)

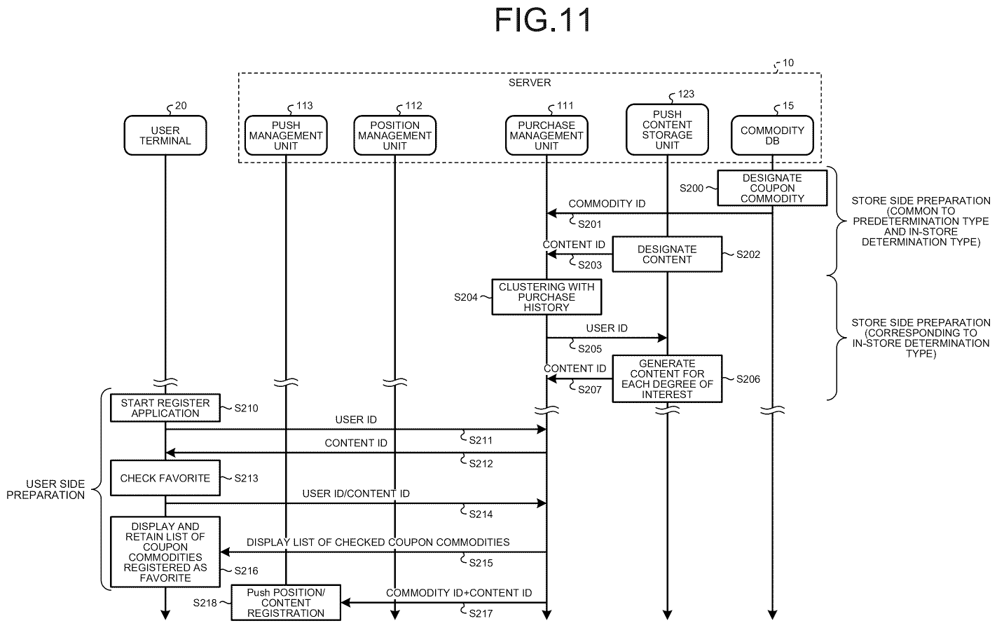

First, preparation on the store side and the user side according to the embodiment is explained. FIG. 11 is a sequence chart of an example for explaining preparation on the store side and the user side according to the embodiment. Note that processing illustrated in FIG. 11 corresponds to the processing in Step S100 to Step S102 in FIG. 10 explained above.

In FIG. 11, the processing in Step S200 to Step S207 indicates preparation processing on the store side. For example, the processing in Step S200 to Step S207 is processing in the server 10 corresponding to operation of a store staff member on the store side management terminal 30. The processing in Step S200 to Step S203 is applied in common to purchase actions of the predetermination type and the in-store determination type. The processing in Step S204 to Step S207 is applied to the purchase action of the in-store determination type.

Prior to the processing according to the sequence chart of FIG. 11, in the store, for example, the store staff member measures a store floor using the store side terminal 31. The store side management terminal 30 combines a measurement result of the store floor and layout information of display shelves and the like arranged on the store floor according to operation of the store staff member to create a store map. The store side management terminal 30 further sets, with respect to the created store map, a push position for notifying the user terminal 20 of notification information.

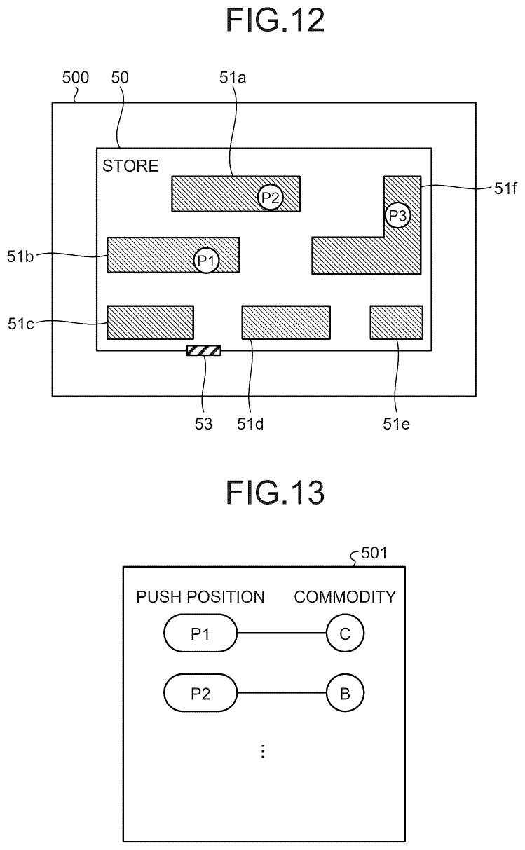

FIG. 12 is a schematic diagram illustrating an example of a store map displayed on the store side management terminal 30. In FIG. 12, a store map 50 is displayed on a store map screen 500. In this example, a frame of the store map 50 is illustrated as corresponding to the outer periphery of a store floor. In the store map 50, display shelves 51a to 51f on which, for example, commodities are displayed are arranged, and an entrance 53 to the store is illustrated on the lower side in the figure of the store floor.

Push positions P1 to P3 where commodities are desired to be pushed are arranged on the store map 50. In this example, the push position P1 is arranged in the display shelf 51b, the push position P2 is arranged in the display shelf 51a, and the push position P3 is arranged in the display shelf 51f. Predetermined push ranges are respectively set for the push positions P1 to P3. When the user terminal 20 is recognized within the push ranges set in the push positions P1 to P3, the server 10 transmits push notification correlated with the push positions to the user terminal 20.

In FIG. 11, in Step S200, the server 10 designates, according to an instruction from the store side management terminal 30, a coupon commodity to which a coupon is applied among commodities stored in the commodity DB 15. Note that the coupon commodity corresponds to a push commodity that the store desires to push. The store side management terminal 30 arranges, according to operation of the store staff member, the designated coupon commodity in the store map 50 in correlation with a push position according to necessity. FIG. 13 is a schematic diagram illustrating an example of a commodity correlation screen displayed on the store side management terminal 30, the commodity correlation screen correlating a commodity with a push position. In FIG. 13, a commodity correlation screen 501 illustrates a situation in which a commodity C is correlated with the push position P1 and the commodity B is correlated with the push position P2.

The commodity DB 15 delivers commodity IDs for identifying commodities A to D, which are respectively designated coupon commodities, to the purchase management unit 111 (Step S201).

Subsequently, in Step S202, the store side management terminal 30 designates contents used for push correlated with the commodities A to D according to operation of the store staff member. For example, the store side management terminal 30 may correlate contents selected from a template stored in advance in the push content storage unit 123 with the commodities A to D according to operation of the store staff member or may correlate contents created anew by the store staff member or the like with the commodities A to D. The push content storage unit 123 delivers content IDs for identifying the designated contents to the purchase management unit 111 (Step S203). The purchase management unit 111 manages the commodity IDs delivered in Step S201 and the content IDs delivered in Step S203 in correlation with each other.

As explained above, Step S204 to Step S207 are preparation on the store side for a purchase action of the in-store determination type. In Step S204, the server 10 refers to purchase histories of users from the user DB 14 and clusters the users with the purchase management unit 111 based on the purchase histories. The purchase management unit 111 delivers user IDs of the clustered users to the push content storage unit 123 in correlation with classification IDs indicating classifications by the clustering (Step S205).

In Step S206, the push content storage unit 123 generates, based on the user IDs and the classification IDs delivered from the purchase management unit 111 in Step S205, for the users for each of the classification IDs, contents for each degree of interest for each of the commodities designated as the coupon commodities (push commodities). For example, the push content storage unit 123 may receive, from the store side management terminal 30, contents for each degree of interest created according to operation of the store staff member in the store side management terminal 30.

Here, as the degree of interest, an indicator indicating the degree of interest may be used. For example, it is assumed that a degree of interest In is indicated by a value of 0≤In≤1. In this case, it is conceivable that an indicator R indicating the degree of interest In is set to, for example, R=1 at 0≤In<0.25, R=2 at 0.25≤In<0.5, R=3 at 0.5≤In<0.75, and R=4 at 0.75≤ In<1. The push content storage unit 123 generates content for each indicator R.

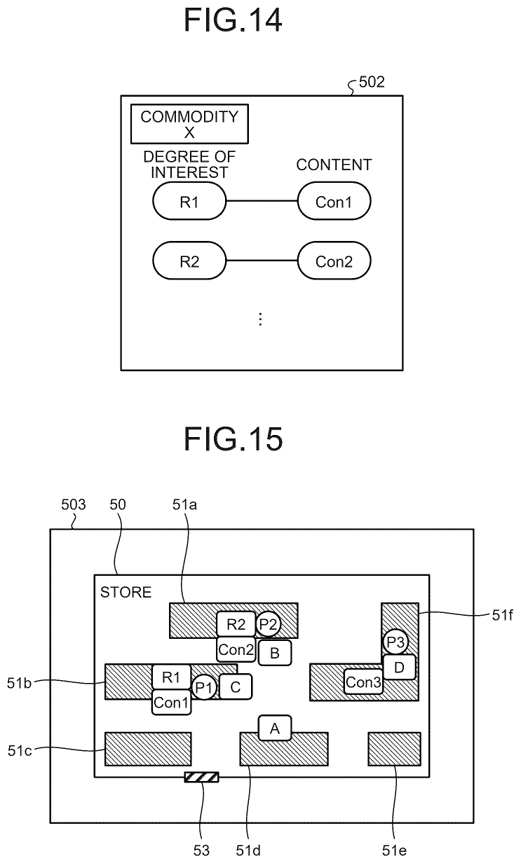

FIG. 14 is a schematic diagram illustrating an example of a degree-of-interest correlation screen for correlating content Con with the indicator R of the degree of interest displayed on the store side management terminal 30. In FIG. 14, a degree-of-interest correlation screen 502 illustrates a situation in which, for a commodity X, content Con1 is correlated with an indicator R1 of a degree of interest and content Con2 is correlated with an indicator R2 of a degree of interest.

The push content storage unit 123 delivers a content ID for identifying the generated content to the purchase management unit 111 (Step S207).

The purchase management unit 111 associates the commodity ID delivered in Step S201 and the content ID delivered in Step S203 and Step S207 with push positions arranged on the store map 50. The server 10 may associate, with the store map storage unit 122, these IDs and information indicating commodities with the push positions on the store map 50. The store map storage unit 122 may deliver, to the management screen presentation unit 124, the store map 50 on which these kinds of information are correlated with the push positions. The management screen presentation unit 124 may generate a map screen for displaying the store map 50, on which the kinds of information are arranged, delivered from the store map storage unit 122 and transmit the map screen to the store side management terminal 30.

FIG. 15 is a schematic diagram illustrating an example of a store map screen 503 displayed on the store side management terminal 30. In the example illustrated in FIG. 15, the store map screen 503 includes the store map 50. In the store map 50, the commodity B, the indicator R2 of the degree of interest, and the content Con2 are correlated with the push position P2 arranged in the display shelf 51a. In addition, in the store map 50, the commodity C, the indicator R1 of the degree of interest, and the content Con1 are correlated with the push position P1 arranged in the display shelf 51b and the commodity D and content Con3 are correlated with the push position P3 arranged in the display shelf 51f.

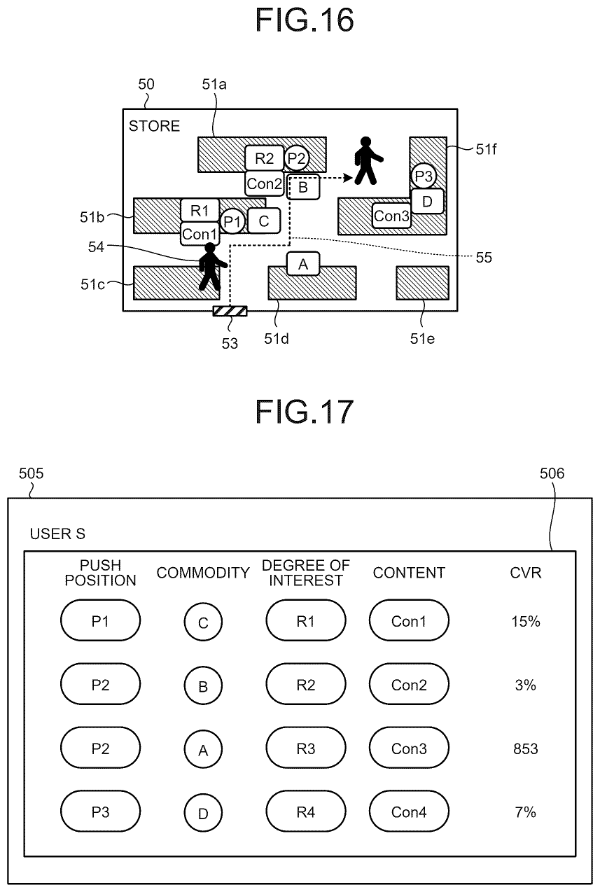

FIG. 16 is a schematic diagram illustrating, in the store map 50 in which commodities, indicators of degrees of interest, and contents are correlated with push positions, an example of a travel route 55 expected for a user 54 who has visited the store. As illustrated in FIG. 16, it is expected that user 54 who enters the store from an entrance 53 moves in the store in the order of the push position P1, the push position P2, and the push position P3. Further, it is expected that the user 54 opens, at the push positions P1, P2, and P3, the contents Con1, Con2, and Con3 included in notification information at the respective positions and purchases the commodities C, B, and D.

FIG. 17 is a schematic diagram illustrating an example of a dashboard screen displayed on the store side management terminal 30. Note that the dashboard screen is one screen on which information collected from a plurality of information sources is displayed.

In FIG. 17, a dashboard screen 505 displays information for each user (user S in this example) in a display region 506. The information displayed in the display region 506 includes records including items of a push position, a commodity, an indicator of a degree of interest (described as degree of interest in the figure), content, and a CVR (Conversion Rate). Note that the CVR is a purchase rate in the store.

For example, in the server 10, the management screen presentation unit 124 may acquire information indicating the push position from the store map storage unit 122. The commodity is, for example, a commodity name. The management screen presentation unit 124 may acquire the commodity from the commodity DB 15. The management screen presentation unit 124 may acquire the content for pushing the commodity from the push content storage unit 123. The management screen presentation unit 124 may acquire the indicator of the degree of interest from, for example, the push content storage unit 123. The management screen presentation unit 124 may acquire the CVR from, for example, the purchase management unit 111. The management screen presentation unit 124 acquires these kinds of information for each user, generates display control information for causing the store side management terminal 30 to display the dashboard screen 505 including the acquired kinds of information in the display region 506, and transmits the generated display control information to the store side management terminal 30.

The store side management terminal 30 displays the dashboard screen 505 illustrated in FIG. 17 according to the display control information transmitted from the server 10. In the example illustrated in FIG. 17, the dashboard screen 505 shows the CVR for the combination of the push position, the commodity, the indicator of the degree of interest, and the content. A combination of commodities having a cross-sell relation for prompting purchase of a related commodity and a combination of commodities having an up-sell relation for prompting purchase of a higher-order commodity may be displayed on the dashboard screen 505. A combination of the commodity, the indicator of the degree of interest, and the content may be displayed for each push position in order corresponding to the CVR.

In addition, in the example illustrated in FIG. 17, the dashboard screen 505 displays one commodity, one indicator of a degree of interest, one content, and one CVR in association with one push position. However, this is not limited to this example. For example, when a plurality of indicators of degrees of interest respectively correlated with different contents are set for commodities, the plurality of indicators of degrees of interest and the contents may be displayed on the dashboard screen 505 in correlation with each other for each of the commodities.

The store side management terminal 30 or the position optimization unit 102 in the server 10 is capable of optimizing, for example, the combination of the push position, the commodity, the indicator of the degree of interest, and the content by causing the machine learning model to learn using the push position, the commodity, the indicator of the degree of interest, the content, and the CVR as parameters.

For example, as illustrated in FIG. 17, it is seen that, concerning the user S, with a combination in a second line concerning the user S, as a result of using the content Con2 when the degree of interest in the commodity B at the push position P2 is the indicator R2, the CVR of only 3% is obtained. On the other hand, with a combination in a third line, as a result of pushing the commodity A at the same push position P2 and using the content Con3 when the degree of interest in the commodity A at the push position P2 is an indicator R3, the CVR of 87% is obtained. In this case, it can be said that the combination in the second row is a failure example and the combination in the third row is a success example.

For example, by applying the machine learning model learned as described above to such a result, it is possible to optimize the combinations of the parameters at the push positions P1, P2, . . . such that the CVR becomes higher. It is also conceivable to generate a combination of parameters capable of promoting cross-sell and up-sell through the optimization using this machine learning model. Further, by accumulating purchase histories of users and causing the machine learning model to learn at any time, it is possible to improve the accuracy of an algorithm of the parameter combination optimization algorithm.

Referring back to FIG. 11, Step S210 and subsequent steps illustrate preparation processing on the user side. That is, processing in Step S210 to Step S218 is processing of the user terminal 20 and the server 10 according to operation of the user on the user terminal 20. Processing in Step S210 to Step S218 is processing performed when a purchase action is of the predetermination type.

In Step S210, the user starts the register application with position function 220 in the user terminal 20. When being started, the register application with position function 220 transmits a user ID, which is identification information for identifying the user who operates the user terminal 20, to the server 10 (Step S211). The server 10 delivers the user ID transmitted from the user terminal 20 to the purchase management unit 111. The purchase management unit 111 transmits flier information including a content ID of content corresponding to the push commodity to the user terminal 20 according to the user ID (Step S212).

When receiving the flier information transmitted from the server 10, the user terminal 20 displays a flier information screen based on the received flier information. The user checks a commodity planned to be purchased or a commodity of interest with user operation referring to the flier information screen displayed on the user terminal 20 and registers the commodity as “favorite” (Step S213).

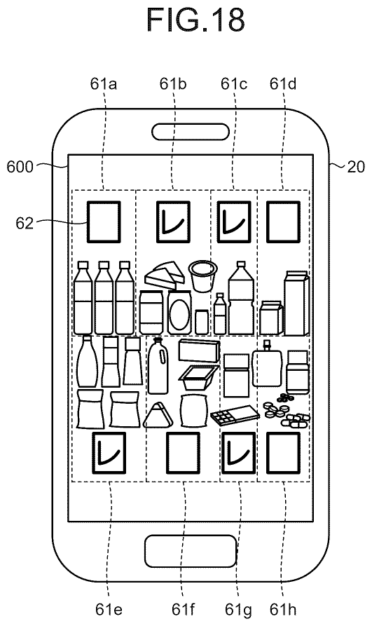

FIG. 18 is a schematic diagram illustrating an example of the flier information screen displayed on the user terminal 20. In the example illustrated in FIG. 18, a flier information screen 600 includes commodity image regions 61a to 61h. The commodity image regions 61a to 61h respectively include images of commodities classified according to categories and check boxes 62. The commodity image regions 61a to 61h are respectively correlated with content IDs corresponding thereto.

Referring to the flier information screen 600, the user checks the check boxes 62 included in commodity image regions including commodities planned to be purchased and commodities of interest among the commodity image regions 61a to 61h. In the illustrated example, the check boxes 62 in the commodity image regions 61b, 61c, 61e, and 61g are checked.

The user terminal 20 transmits, to the server 10, a user ID and content IDs corresponding to the commodities for which the check boxes 62 are checked (Step S214). The server 10 delivers the user ID and the content IDs transmitted from the user terminal 20 to the purchase management unit 111. The purchase management unit 111 transmits, according to the content IDs, information for displaying a list of coupon commodities (push commodities) checked as “favorite” by the user to the user terminal 20 (Step S215).

The user terminal 20 receives the information transmitted from the server 10 in Step S215 to register the checked coupon commodities as “favorite” and retain the coupon commodities registered as the “favorite” in the storage device 2004 or the like. The user terminal 20 displays a list of coupon commodities registered as the “favorite” (Step S216).

In the server 10, when the information is transmitted to the user terminal 20 in Step S215, in Step S217, the purchase management unit 111 delivers commodity

IDs of the coupon commodities checked as the “favorite” and content IDs of contents for pushing the coupon commodities to the push management unit 113 in correlation with each other. The push management unit 113 correlates the commodity IDs and the content IDs delivered from the purchase management unit 111 with push positions of the commodities having the commodity IDs and registers the contents having the content IDs.

### (2-3-2. Measures Taken for the Predetermination Type According to the Embodiment)

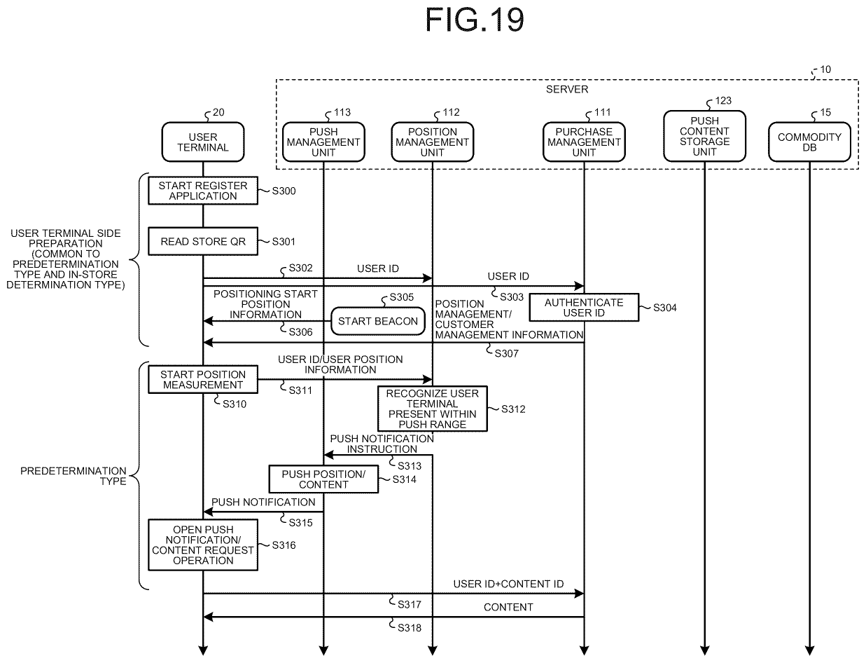

Subsequently, measures taken when a user whose purchase action is the predetermination type has visited the store according to the embodiment is explained. FIG. 19 is a sequence chart of an example for explaining processing performed when the user whose purchase action is the predetermination type has visited the store according to the embodiment.

In FIG. 19, processing in Step S300 to Step S307 indicates preparation processing by the user terminal 20 and is common processing performed when a purchase action of the user is the predetermination type and a case in which the purchase action is the in-store determination type. First, processing in Step S300 to Step S307 is explained.

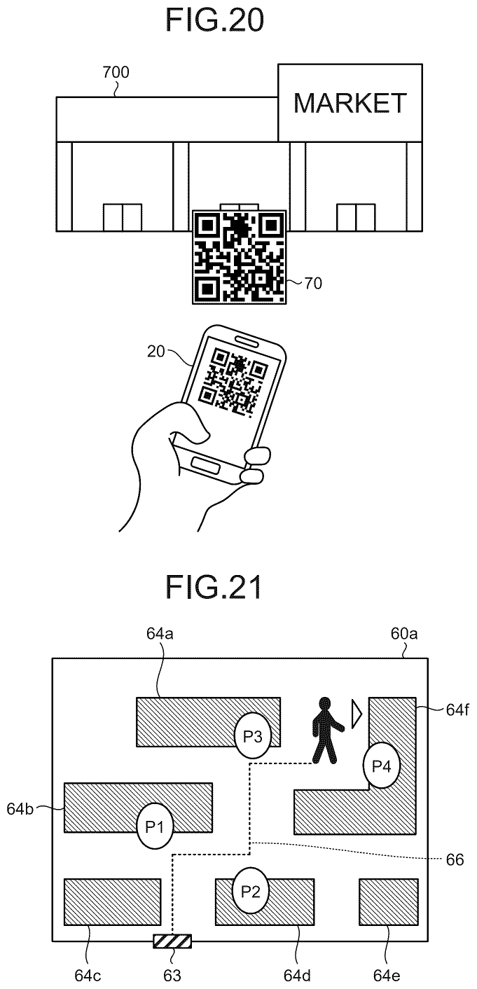

When entering the store, the user operates the user terminal 20 to start the register application with position function 220 (Step S300). As schematically illustrated in FIG. 20, the user reads a QR code 70 posted at, for example, an entrance of a real store 700 using the camera function of the user terminal 20 (Step S301). Note that, without being limited to this example, the register application with position function 220 may be automatically started in the user terminal 20 by reading the QR code 70 using the camera function of the user terminal 20.

When reading the QR code 70, the register application with position function 220 transmits a user ID of the user who uses the user terminal 20 to the server 10. The server 10 delivers the user ID transmitted from the user terminal 20 to the position management unit 112 and the purchase management unit 111 (Step S302, Step S303).

The purchase management unit 111 authenticates the user ID referring to the user DB 14 based on the user ID transmitted from the user terminal 20 (Step S304). When succeeding in the authentication of the user ID, in Step S307, the purchase management unit 111 transmits position management information managed as the push position 2220, the degree of interest 2221, and the predicted route 2222 in the position management unit 222 of the user terminal 20 to the user terminal 20. In Step S307, the purchase management unit 111 transmits the user management information managed as the push content reaction history 2210, the favorite registration list 2211, and the purchase history 2212 in the user management unit 221 of the user terminal 20 to the user terminal 20. The user terminal 20 retains the respective kinds of information transmitted from the purchase management unit 111 with the user management unit 221 and the position management unit 222.

The server 10 starts beacon processing according to the user's visit to the store (Step S305) and transmits, to the user terminal 20, position information (for example, a posting position of the QR code 70) indicating a position where positioning is started (Step S306).

In FIG. 19, processing in Step S310 and subsequent steps is processing performed when a purchase action of the user is the predetermination type.

In Step S310, the user terminal 20 starts position measurement. At this time, based on the position management information transmitted from the server 10 in Step S307, the user terminal 20 can cause the display unit 202 to display a store map including the positions of commodities registered as “favorites” and a predicted route at the time when the user moves in the store based on the positions.

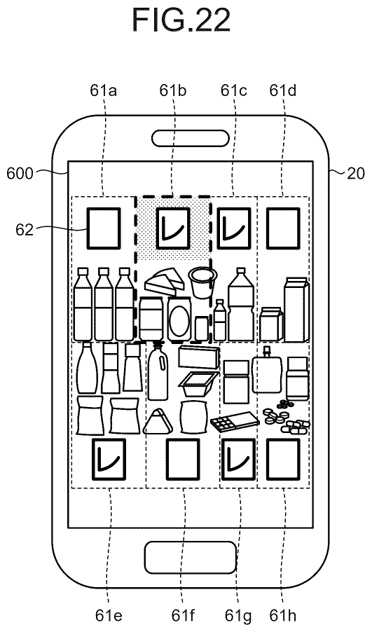

FIG. 21 is a schematic diagram illustrating an example of a store map displayed on the user terminal 20 in Step S310 according to the embodiment. In FIG. 21, a store map 60a shows an entrance 63, display shelves 64a to 64f arranged in a store floor, and push positions P1 to P4 of commodities registered as “favorite” by the user. In the example illustrated in FIG. 21, the push position P1 is arranged in the display shelf 64b, the push position P2 is arranged in the display shelf 64d, the push position P3 is arranged in the display shelf 64a, and the push position P4 is arranged in the display shelf 64f. The store map 60a further displays a route 66 predicted for the user to go around the push positions P1 to P4. The user is capable of efficiently going around the push positions P1 to P4 by moving in the store floor according to the route 66.

The user moves in the store floor while holding the user terminal 20, for example, in a state in which the register application with position function 220 is started. The user terminal 20 sequentially transmits the user ID and user position information indicating the position of the user terminal 20 to the server 10 (Step S311). Note that the user terminal 20 may transmit the user position information including information indicating the direction of the user terminal 20.

The server 10 delivers the user ID and the user position information transmitted from the user terminal 20 to the position management unit 112. The position management unit 112 refers to the delivered user position information and the push positions P1 to P4 and recognizes the user terminal 20 present within a push range of any one of the push positions P1 to P4 (Step S312). Here, for explanation, it is assumed that the position management unit 112 recognizes the user terminal 20 present within the push range of the push position P1.

The position management unit 112 delivers, to the push management unit 113, an instruction to perform push notification to the user terminal 20 present within the push range of the push position P1 together with the user ID of the user terminal (Step S313).

According to the push notification instruction delivered from the position management unit 112, the push management unit 113 transmits push notification by the push position P1 to the user terminal 20 corresponding to the user ID delivered from the position management unit 112 (Step S315).

When the push notification transmitted from the server 10 is received by the user terminal 20, the user opens the received push notification and performs, on the user terminal 20, predetermined operation for requesting content correlated with the push position P1 (Step S316).

FIG. 22 is a schematic diagram illustrating an example of display by the user terminal 20 at the time when the push notification is opened according to the embodiment. In the example illustrated in FIG. 22, on the flier information screen 600 described with reference to FIG. 18, the commodity image region 61b corresponding to the push position P1 is highlighted, indicating that the position of the user terminal 20 is present within the push range of the push position P1. As predetermined operation, for example, the user taps the highlighted commodity image region 61b to request the user terminal 20 to transmit content correlated with the push position P1.

When the predetermined operation is performed by the user, the user terminal 20 transmits the user ID and content ID of the requested content to the server 10 (Step S317). The server 10 delivers the user ID and the content ID transmitted from the user terminal 20 to the purchase management unit 111. The purchase management unit 111 transmits the content correlated with the delivered content ID to the user terminal 20 corresponding to the delivered user ID (Step S318).

The user terminal 20 receives and displays the content transmitted from the server 10. The user can determine, referring to the content displayed on the user terminal 20, whether to purchase a commodity at the push position P1.

### 2-3-3. Measures Taken for the In-Store Determination Type According to the Embodiment

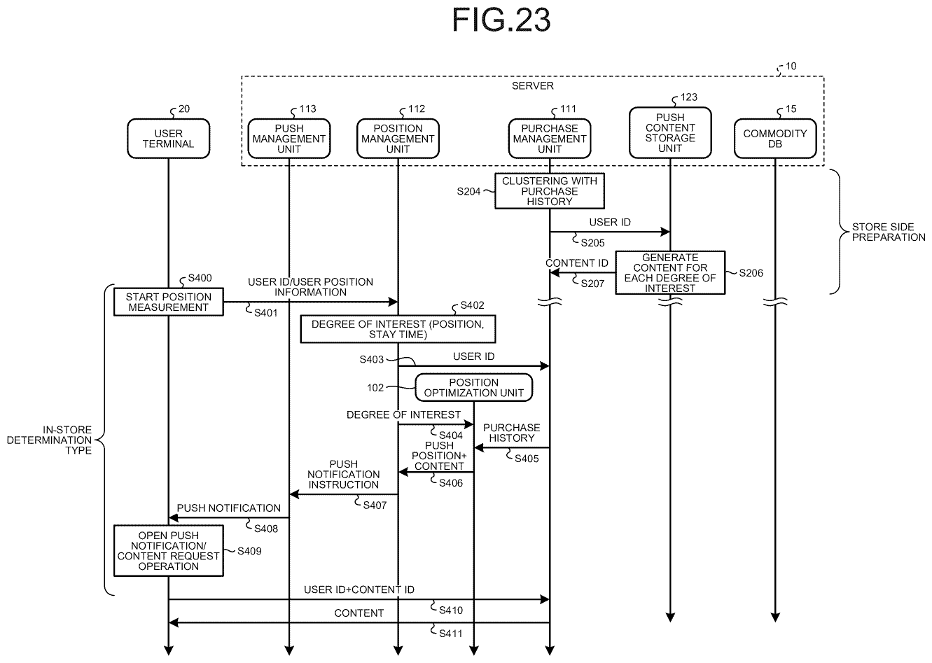

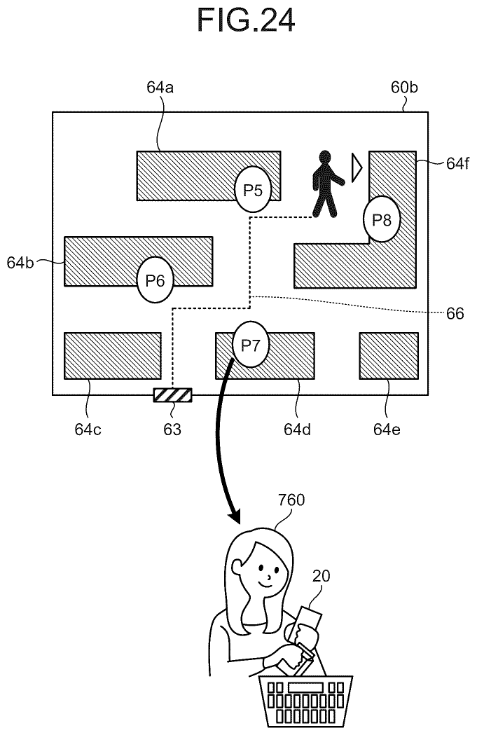

Subsequently, measures taken when a user whose purchase action is in-store determination type has visited the store according to the embodiment is explained. FIG. 23 is a sequence chart of an example for explaining processing performed when the user whose purchase action is in-store determination type has visited the store according to an embodiment.

In FIG. 23, as indicated by Step S204 to Step S207, the store side management terminal 30 prepares for the purchase action of the in-store determination type on the sore side. Since processing in Step S204 to Step S207 in FIG. 23 is the same as the processing in Step S204 to Step S207 explained with reference to FIG. 11, explanation of the processing is omitted here. Since preparation processing in the user terminal 20 is common to the processing in Step S300 to Step S307 explained with reference to FIG. 19, explanation of the preparation processing is omitted here.

In Step S400, the user terminal 20 starts position measurement. The user moves in the store floor while holding the user terminal 20, for example, in a state in which the register application with position function 220 is started. The user terminal 20 sequentially transmits a user ID and user position information indicating the position of the user terminal 20 to the server 10 (Step S401). Note that the user terminal 20 transmits the user position information including information indicating the direction of the user terminal 20.

The server 10 delivers the user ID and the user position information transmitted from the user terminal 20 to the position management unit 112. The position management unit 112 calculates a degree of interest of the user in a push commodity based on the delivered user position information (Step S402).

For example, based on the user position information, the position management unit 112 determines whether the user terminal 20 is present within a push range of any push commodity and is facing the direction of the push commodity. When determining that the user terminal 20 is present within the push range of any push commodity and is facing the direction of the push commodity, the position management unit 112 measures a time in which the user terminal 20 stays at a push position of the push commodity. Note that the stay is not limited to the user terminal 20 staying in the place and may include a state in which the user terminal 20 is moving at speed equal to or lower than predetermined speed in the place.

The position management unit 112 calculates a degree of interest of the user in the push commodity based on the measured stay time. For example, the position management unit 112 converts the stay time into a degree of interest and sets a high degree of interest as the stay time is longer. For example, when the calculated degree of interest is equal to or higher than a predetermined degree of interest, the position management unit 112 delivers a user ID corresponding to the degree of interest to the purchase management unit 111 and delivers the degree of interest to the position optimization unit 102 (Step S403, Step S404).

The purchase management unit 111 refers to the user DB 14 based on the user ID delivered from the position management unit 112 and extracts a purchase history correlated with the user ID from the user DB 14. The purchase management unit 111 delivers the extracted purchase history to the position optimization unit 102 in correlation with the user ID (Step S405).

Based on the degree of interest delivered from the position management unit 112 and the purchase history delivered from the purchase management unit 111, the position optimization unit 102 acquires a push position where a commodity should be pushed to the user indicated by the user ID and content presented to the user at the push position. At this time, the position optimization unit 102 acquires content corresponding to the degree of interest. The position optimization unit 102 delivers the acquired push position and the acquired content to the position management unit 112 (Step S406).

The position management unit 112 delivers a push notification instruction including the push position and the content delivered from the position optimization unit 102 to the push management unit 113 (Step S407). When the position management unit 112 determines, based on the user position information transmitted from the user terminal 20, that the user terminal 20 used by the user indicated by the user ID is present within a push range of the push position included in the push notification instruction, the server 10 transmits push notification including the content ID to the user terminal 20 (Step S408).

When the push notification transmitted from the server 10 is received by the user terminal 20, the user opens the received push notification and performs, on the user terminal 20, predetermined operation for requesting content correlated with the push position (Step S409).

When the predetermined operation is performed by the user, the user terminal 20 transmits the user ID and a content ID of the requested content to the server 10 (Step S410). The server 10 delivers the user ID and the content ID transmitted from the user terminal 20 to the purchase management unit 111. The purchase management unit 111 transmits the content correlated with the delivered content ID to the user terminal 20 corresponding to the delivered user ID (Step S411).

The user terminal 20 receives and displays the content transmitted from the server 10. The user can determine, referring to the content displayed on the user terminal 20, whether to purchase a commodity at the push position.

FIG. 24 is a schematic diagram for explaining that push notification is transmitted to the user terminal 20 of a user present within a push range of a push position. In a store map 60b illustrated in FIG. 24, push positions P5, P6, P7, and P8 are respectively arranged in the display shelves 64a, 64b, 64d, and 64f and a user 760 moves in the store as indicated by the route 66.

At the push position P6 to which the user 760 approaches first, when a degree of interest is lower than a predetermined degree of interest because a stay time is shorter than a predetermined time or the user 760 is not facing the direction of the push position P6, the server 10 does not transmit push notification to the user terminal 20 of the user 760 within a push range of the push position P6. On the other hand, at the push position P7 to which the user 760 approaches next, when a stay time is equal to or longer than the predetermined time and the user 760 is facing the direction of the push position P7, the server 10 transmits push notification to the user terminal 20 of the user 760. The user 760 can open the push notification with the user terminal 20 and examine purchase of a push commodity at the push position P7 referring to requested content.

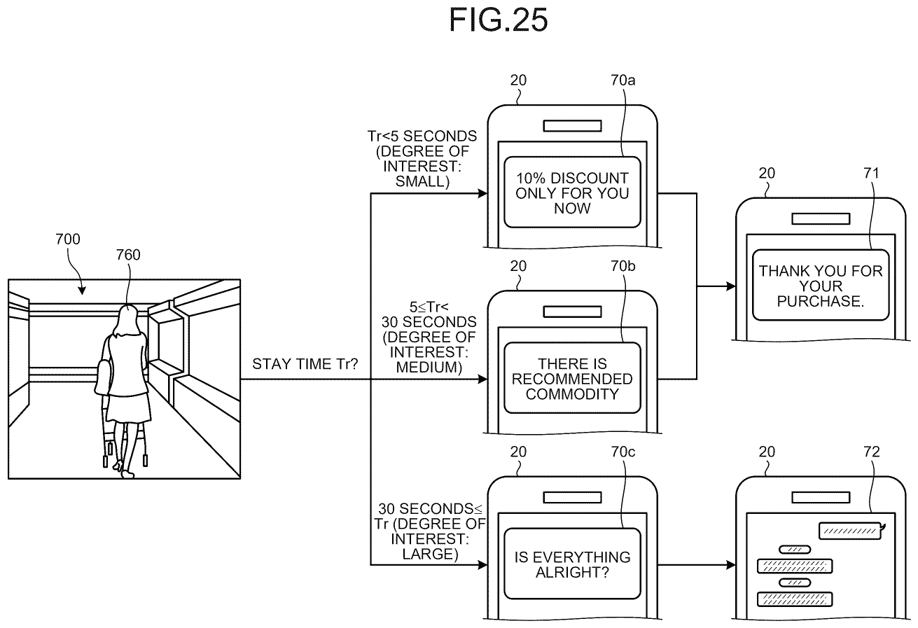

FIG. 25 is a schematic diagram illustrating an example of content corresponding to a degree of interest according to the embodiment. It is assumed that, while touring around the real store 700, the user 760 stays within a push range of a certain push position P for a predetermined time while facing the direction of the push position P. The time in which the user 760 stays at this time is represented as stay time Tr.

The position optimization unit 102 can transmit different content to the user terminal 20 according to the stay time Tr. In the example illustrated in FIG. 25, the position optimization unit 102 classifies the stay time Tr into three stages of (1) Tr<5 seconds, (2) 5 seconds≤Tr<30 seconds, and (3) 30 seconds≤Tr in order from the smallest degree of interest.

In the example illustrated in FIG. 25, the position optimization unit 102 selects, for example, a message 70a indicating a price-cut as content in (1) Tr<5 seconds in which a degree of interest is the smallest and selects a message 70b for introducing still another commodity in (2) 5 seconds≤Tr<30 seconds in which the degree of interest is medium. When a commodity is purchased according to these messages 70a and 70b, the server 10 may transmit a message 71 of gratitude for the purchase to the user terminal 20 as further content.

On the other hand, in the example illustrated in FIG. 25, the position optimization unit 102 selects, assuming that the user is uncertain about whether to purchase the commodity, a message 70c for requesting assistance as content at (3) 30 seconds≤Tr in which the degree of interest is the highest. In this case, the user terminal 20 transmits a request for assistance to the server 10 according to predetermined operation by the user 760. In response to this request, the server 10 may transmit, as further content, to the user terminal 20, for example, a chat screen 72 for performing chat by a chatbot that automatically executes conversation (chat) via a network using artificial intelligence. Not only this, but the server 10 can also call a store staff member of the real store 700 in response to the request for assistance from the user terminal 20.

### (2-3-4. Settlement Processing According to the Embodiment)

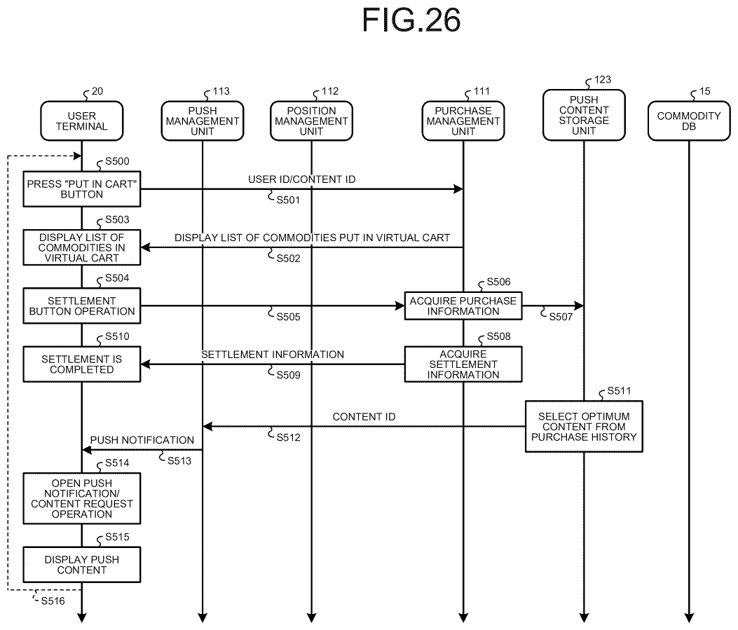

Subsequently, settlement processing according to the embodiment is explained. FIG. 26 is a sequence chart of an example for explaining the settlement processing according to the embodiment.

When purchasing a push commodity notified by push notification, the user puts the push commodity to be purchased in, for example, a shopping basket in the real world and operates a “put in cart” button (not illustrated) for putting the push commodity in a virtual cart displayed on the user terminal 20 (Step S500). Note that, since the push notification of the push commodity includes information equivalent to a barcode, it is unnecessary to execute scanning of the barcode.

According to the operation of the “put in cart” button, the user terminal 20 transmits a user ID and a content ID correlated with the push commodity to the server 10. The server 10 delivers the user ID and the content ID transmitted from the user terminal 20 to the purchase management unit 111.

The purchase management unit 111 transmits, according to the delivered user ID and the delivered content ID, to the user terminal 20, information concerning commodities for displaying a list of commodities put in a virtual cart (Step S502). The user terminal 20 displays the list of commodities on the virtual cart according to the information transmitted from the server 10.

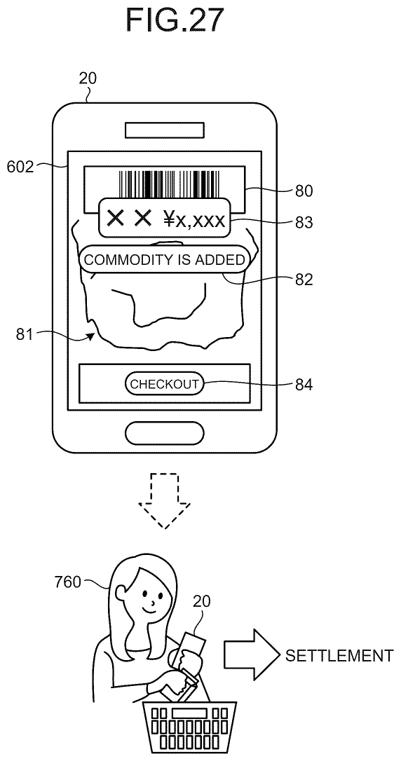

FIG. 27 is a schematic diagram illustrating an example of a list display screen for displaying a list of commodities in a virtual cart according to the embodiment. In the example illustrated in FIG. 27, a list display screen 602 displays an image 81 of a push commodity put in the virtual cart, a barcode 80 included in push information correlated with the push commodity, a message 82 indicating that the commodity has been put in the virtual cart, and commodity information 83 included in the barcode 80. In the example illustrated in FIG. 27, since only one commodity is put in the virtual cart, only information concerning the one commodity is displayed on the list display screen 602.

Referring back to FIG. 26, when actually purchasing the commodity displayed on the list display screen 602, the user operates a settlement button 84 (described as “checkout” in the figure) provided on the list display screen 602 of the user terminal 20 (Step S504). According to the operation on the settlement button 84, the user terminal 20 transmits purchase information for purchasing the commodity put in the virtual cart to the server 10 (Step S505). The purchase information may include, for example, a commodity ID for identifying the commodity displayed on the list display screen 602.

The server 10 delivers the purchase information transmitted from the user terminal 20 to the purchase management unit 111. When acquiring the purchase information, the purchase management unit 111 requests, according to the acquired purchase information, the settlement server 40 to perform settlement (Step S506). When acquiring settlement information indicating settlement completion from the settlement server 40 (Step S508), the purchase management unit 111 transmits the acquired settlement information to the user terminal 20 (Step S509).

When the user terminal 20 acquires the settlement information transmitted from the server, the settlement concerning the push commodity put in the virtual cart is completed (Step S510).

When acquiring the purchase information in Step S506 explained above, the purchase management unit 111 delivers the acquired purchase information to the push content storage unit 123 (Step S507). The push content storage unit 123 selects, based on the purchase information delivered from the purchase management unit 111 and a purchase history stored in the user DB 14 in correlation with the user ID, optimum content for prompting the user to purchase a further commodity (Step S511). The push content storage unit 123 delivers a content ID of the selected content to the push management unit 113 (Step S512).

The push management unit 113 transmits push notification including the content ID delivered from the push content storage unit 123 to the user terminal 20 (Step S513).

When the push notification transmitted from the server 10 is received by the user terminal 20, the user opens the received push notification and performs, on the user terminal 20, predetermined operation for requesting content correlated with the push position (Step S514).

When the predetermined operation is performed by the user, the user terminal 20 transmits the user ID and a content ID of the requested content to the server 10. The server 10 delivers the user ID and the content ID transmitted from the user terminal 20 to the purchase management unit 111. The purchase management unit 111 transmits the content correlated with the delivered content ID to the user terminal 20 corresponding to the delivered user ID.

The user terminal 20 receives and displays the content transmitted from the server 10 (Step S515). The user can determine, referring to the content displayed on the user terminal 20, whether to purchase a commodity at the push position.

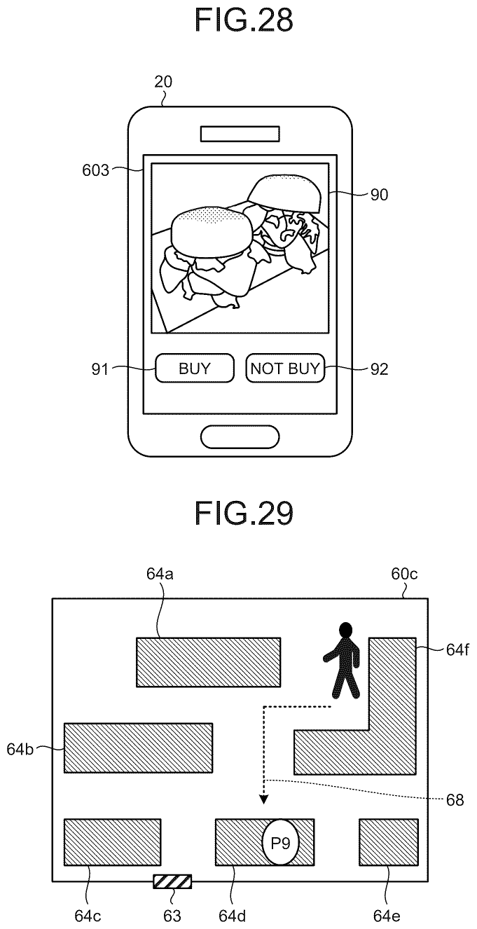

FIG. 28 is a schematic diagram illustrating an example of a content display screen that displays the content for prompting further purchase received in Step S515 according to the embodiment. In FIG. 28, on a content display screen 603, an image 90 of a push commodity is used as content for prompting purchase of the push commodity.

On the content display screen 603, a purchase button 91 (displayed as “buy” in the figure) for deciding purchase of the push commodity and a cancel button 92 (displayed as “not buy” in the figure) for canceling the purchase of the push commodity are arranged.

When purchasing the push commodity displayed on the image 90, the user operates the purchase button 91. According to the operation of the purchase button 91 by the user, the user terminal 20 returns the processing to Step S500 in the sequence chart of FIG. 26. At this time, it is preferable that the user terminal 20 superimposes and displays, on the store map, a route for moving to the position of the push commodity determined to be purchased and navigates the user to the position of the push commodity.

FIG. 29 is a schematic diagram illustrating an example of a store map, on which navigation information to an additionally pushed push commodity position is superimposed, according to the embodiment. In FIG. 29, in a store map 60c, a push position P9 of an additionally pushed push commodity is arranged. For example, when the current position of the user (the user terminal 20) is the vicinity of the display shelf 64f, a route 68 for moving from the current position of the user to the push position P9 is superimposed on the store map 60c.

By causing the user terminal 20 to display the store map 60c, the user can easily move to the position of a push commodity, information of which the user does not have in advance. Therefore, in a state in which a purchase desire for an additionally pushed push commodity is maintained, the user can move to the position of the push commodity. It is possible to improve a purchase rate of the push commodity.

Note that the effects described in this specification are only illustrations and are not limited. Other effects may be present.

Note that the present technique can also take the following configurations.
(1) An information processing device comprising:
   a service management unit that manages a notification position for providing notification of provision of a service corresponding to a degree of interest of a user, the notification position being arranged with respect to map information; and
   a user management unit that acquires, based on the map information, a position of a user terminal identified based on identification information for identifying the user and transmits notification to the user terminal when the position of the user terminal is within a notification range of the notification position.
(2) The information processing device according to the above (1), further comprising
   a position optimization unit that optimizes the notification position based on a use history of the service by the user terminal and a degree of interest of the user, who uses the user terminal, in a service based on the use history.
(3) The information processing device according to the above (2), wherein
   the user management unit
   calculates, based on a stay time and a posture of the user terminal within the notification range, the degree of interest in the service by the user who is using the user terminal.
(4) The information processing device according to the above (2) or (3), wherein,
   after the notification, the user management unit
   further transmits notification of provision of a service relating to the service corresponding to the notification position.
(5) The information processing device according to the above (4), wherein
   the user management unit
   transmits, to the user terminal, the notification including the map information on which information indicating a route to a notification position for providing notification of provision of a service managed by the service relating to the service corresponding to the notification position managed by the service management unit is superimposed.
(6) The information processing device according to any one of the above (2) to (5), wherein
   the service management unit
   manages the notification position in correlation with a position where the service is provided,
   manages, in correlation with each other, an indicator of the degree of interest in the service and content used in notifying the user terminal of the service, and
   manages the indicator and the content correlated with the indicator in correlation with the notification position.
(7) The information processing device according to the above (6), wherein
   the user management unit
   transmits the notification including the content correlated with the indicator corresponding to the degree of interest to the user terminal according to the degree of interest in the service by the user who is using the user terminal.
(8) The information processing device according to the above (7), wherein
   the user management unit
   transmits the notification including a conversation environment to the user terminal when the degree of interest in the service by the user is equal to or higher than a predetermined degree of interest.
(9) The information processing device according to any one of the above (1) to (8), wherein
   the user management unit
   transmit, to the user terminal, the map information on which information indicating a route to a notification position designated in advance using the user terminal in the notification positions is superimposed.
(10) An information processing method executed by a processor, comprising:
   a service management step of managing a notification position for providing notification of provision of a service corresponding to a degree of interest of a user, the notification position being arranged with respect to map information; and
   a user management step of acquiring, based on the map information, a position of a user terminal identified based on identification information for identifying the user and transmitting notification to the user terminal when the position of the user terminal is within a notification range of the notification position.
(11) An information processing device comprising:
   a detection unit that detects at least a current position in a service providing region for providing a service corresponding to a degree of interest of a user;
   a communication unit that performs communication via a network; and
   a display control unit that displays a screen on a display unit, wherein
   the display control unit
   causes the display unit to display information based on notification at a notification position corresponding to the current position in map information indicating the service providing region, the information being acquired via the network according to the position detected by the detection unit.
(12) The information processing device according to the above (11), wherein
   the display control unit
   causes the display unit to display the notification position and a route to the notification position in the map information to be superimposed on the map information.
(13) The information processing device according to the above (11) or (12), wherein
   the detection unit
   further detects a posture of the information processing device, and
   the display control unit
   transmits a degree of interest calculated based on a stay time at the position detected by the detection unit and the detected posture to the network and causes, according to the transmitted degree of interest, the display unit to display the notification acquired via the network.
(14) The information processing device according to the above (13), wherein
   the notification includes content corresponding to the degree of interest, the content relating to notification of the service corresponding to the notification position where the notification is obtained, and
   the display control unit
   causes the display unit to display the content.
(15) The information processing device according to the above (14), wherein,
   when the degree of interest is equal to or higher than a predetermined degree of interest, the display control unit
   causes the display unit to display the notification including a conversation environment as the content.
(16) The information processing device according to any one of the above (11) to (15), further comprising
   a management unit that retains information indicating a service selected from presented services according to user operation, wherein
   the display control unit
   causes the display unit to display the map information on which information indicating a route to a notification position corresponding to the selected service retained in the management unit in the notification positions is superimposed.
(17) An information processing program for causing a processor to execute:
   a detection step of detecting at least a current position in a service providing region for providing a service corresponding to a degree of interest of a user;
   a communication step of performing communication via a network; and
   a display control step of displaying a screen on a display unit, wherein
   the display control step
   causes the display unit to display information based on notification at a notification position corresponding to the current position in map information indicating the service providing region, the information being acquired via the network according to the position detected by the detection step.
(18) An information processing device comprising:
   an input control unit that performs control corresponding to user operation;
   a display control unit that causes a display unit to display information; and
   a communication unit that performs communication via a network, wherein
   the input control unit
   arranges, with respect to map information indicating a service providing region for providing a service corresponding to a degree of interest of a service recipient, according to the user operation, a notification position for providing notification of information concerning the service and transmits the map information in which the notification position is arranged to the network.
(19) The information processing device according to the above (18), wherein
   the input control unit
   controls, according to the user operation:
   correlation of the notification position with a position where the service is provided;
   correlation of an indicator of a degree of interest in the service and content used in notifying a user terminal of the service; and
   correlation, with the notification position, of the indicator and the content correlated with the indicator.
(20) An information processing program for a processor to execute:
   an input control step of performing control corresponding to a user operation;
   a display control step of causing a display unit to display information; and
   a communication step of performing communication via a network, wherein
   the input control step
   arranges, with respect to map information indicating a service providing region for providing a service corresponding to a degree of interest of a service recipient, according to the user operation, a notification position for providing notification of information concerning the service and transmits the map information in which the notification position is arranged to the network.
(21) An information processing system including:
   a server device; and
   a terminal device that communicates with the server device via a network, in which
   the server device includes:
   a service management unit that manages a notification position for providing notification of provision of a service corresponding to a degree of interest of a user, the notification position being arranged with respect to map information; and
   a user management unit that acquires, based on the map information, a position of a user terminal identified based on identification information for identifying the user and transmits notification to the user terminal when the position of the user terminal is within a notification range of the notification position,
   the terminal device includes:
   a detection unit that detects at least a current position in a service providing region for providing a service corresponding to a degree of interest of the user; and
   a display control unit that displays a screen on a display unit, and
   the display control unit
   causes the display unit to display information based on the notification at the notification position corresponding to the current position in the map information indicating the service providing region, the information being acquired from the server device according to the current position detected by the detection unit.

### REFERENCE SIGNS LIST

1 INFORMATION PROCESSING SYSTEM
2 INTERNET
3 CLOUD NETWORK
10 SERVER
14 USER DB
15 COMMODITY DB
20 USER TERMINAL
30 STORE SIDE MANAGEMENT TERMINAL
50, 60a, 60b, 60c STORE MAP
70a, 70b, 70c, 71 MESSAGE
72 CHAT SCREEN
84 SETTLEMENT BUTTON
102 POSITION OPTIMIZATION UNIT
110, 221 USER MANAGEMENT UNIT
111 PURCHASE MANAGEMENT UNIT
112, 222 POSITION MANAGEMENT UNIT
113 PUSH MANAGEMENT UNIT
120, 223 COMMODITY MANAGEMENT UNIT
122 STORE MAP STORAGE UNIT
123 PUSH CONTENT STORAGE UNIT
124 MANAGEMENT SCREEN PRESENTATION UNIT
210 POSITION ACQUISITION UNIT
211 POSTURE ACQUISITION UNIT
220 REGISTER APPLICATION WITH POSITION FUNCTION
320a, 320b, 320c MAP INFORMATION
340 NOTIFICATION INFORMATION
500, 503 STORE MAP SCREEN
501 COMMODITY CORRELATION SCREEN
502 DEGREE-OF-INTEREST CORRELATION SCREEN
505 DASHBOARD SCREEN
600 FLIER INFORMATION SCREEN
602 LIST DISPLAY SCREEN
603 CONTENT DISPLAY SCREEN
2210 PUSH CONTENT REACTION HISTORY
2211 FAVORITE REGISTRATION LIST
2212 PURCHASE HISTORY
2220 PUSH POSITION
2221 DEGREE OF INTEREST
2222 PREDICTED ROUTE
2230 COMMODITY INFORMATION
2231 CART INFORMATION
2232 SETTLEMENT INFORMATION

1. An information processing device comprising:
a service management unit that manages a notification position for providing notification of provision of a service corresponding to a degree of interest of a user, the notification position being arranged with respect to map information; and
a user management unit that acquires, based on the map information, a position of a user terminal identified based on identification information for identifying the user and transmits notification to the user terminal when the position of the user terminal is within a notification range of the notification position.

2. The information processing device according to claim 1, further comprising
a position optimization unit that optimizes the notification position based on a use history of the service by the user terminal and a degree of interest of the user, who uses the user terminal, in a service based on the use history.

3. The information processing device according to claim 2, wherein
the user management unit
calculates, based on a stay time and a posture of the user terminal within the notification range, the degree of interest in the service by the user who is using the user terminal.

4. The information processing device according to claim 2, wherein,
after the notification, the user management unit
further transmits notification of provision of a service relating to the service corresponding to the notification position.

5. The information processing device according to claim 4, wherein
the user management unit
transmits, to the user terminal, the notification including the map information on which information indicating a route to a notification position for providing notification of provision of a service managed by the service relating to the service corresponding to the notification position managed by the service management is superimposed.

6. The information processing device according to claim 2, wherein
the service management unit
manages the notification position in correlation with a position where the service is provided,
manages, in correlation with each other, an indicator of the degree of interest in the service and content used in notifying the user terminal of the service, and
manages the indicator and the content correlated with the indicator in correlation with the notification position.

7. The information processing device according to claim 6, wherein
the user management unit
transmits the notification including the content correlated with the indicator corresponding to the degree of interest to the user terminal according to the degree of interest in the service by the user who is using the user terminal.

8. The information processing device according to claim 7, wherein
the user management unit
transmits the notification including a conversation environment to the user terminal when the degree of interest in the service by the user is equal to or higher than a predetermined degree of interest.

9. The information processing device according to claim 1, wherein
the user management unit
transmit, to the user terminal, the map information on which information indicating a route to a notification position designated in advance using the user terminal in the notification positions is superimposed.

10. An information processing method executed by a processor, comprising:
a service management step of managing a notification position for providing notification of provision of a service corresponding to a degree of interest of a user, the notification position being arranged with respect to map information; and
a user management step of acquiring, based on the map information, a position of a user terminal identified based on identification information for identifying the user and transmitting notification to the user terminal when the position of the user terminal is within a notification range of the notification position.

11. An information processing device comprising:
a detection unit that detects at least a current position in a service providing region for providing a service corresponding to a degree of interest of a user;
a communication unit that performs communication via a network; and
a display control unit that displays a screen on a display unit, wherein
the display control unit
causes the display unit to display information based on notification at a notification position corresponding to the current position in map information indicating the service providing region, the information being acquired via the network according to the position detected by the detection unit.

12. The information processing device according to claim 11, wherein
the display control unit
causes the display unit to display the notification position and a route to the notification position in the map information to be superimposed on the map information.

13. The information processing device according to claim 11, wherein
the detection unit
further detects a posture of the information processing device, and
the display control unit
transmits a degree of interest calculated based on a stay time at the position detected by the detection unit and the detected posture to the network and causes, according to the transmitted degree of interest, the display unit to display the notification acquired via the network.

14. The information processing device according to claim 13, wherein
the notification includes content corresponding to the degree of interest, the content relating to notification of the service corresponding to the notification position where the notification is obtained, and
the display control unit
causes the display unit to display the content.

15. The information processing device according to claim 14, wherein,
when the degree of interest is equal to or higher than a predetermined degree of interest, the display control unit
causes the display unit to display the notification including a conversation environment as the content.

16. The information processing device according to claim 11, further comprising
a management unit that retains information indicating a service selected from presented services according to user operation, wherein
the display control unit
causes the display unit to display the map information on which information indicating a route to a notification position corresponding to the selected service retained in the management unit in the notification positions is superimposed.

17. An information processing program for causing a processor to execute:
a detection step of detecting at least a current position in a service providing region for providing a service corresponding to a degree of interest of a user;
a communication step of performing communication via a network; and
a display control step of displaying a screen on a display unit, wherein
the display control step
causes the display unit to display information based on notification at a notification position corresponding to the current position in map information indicating the service providing region, the information being acquired via the network according to the position detected by the detection step.

18. An information processing device comprising:
an input control unit that performs control corresponding to user operation;
a display control unit that causes a display unit to display information; and
a communication unit that performs communication via a network, wherein
the input control unit
arranges, with respect to map information indicating a service providing region for providing a service corresponding to a degree of interest of a service recipient, according to the user operation, a notification position for providing notification of information concerning the service and transmits the map information in which the notification position is arranged to the network.

19. The information processing device according to claim 18, wherein
the input control unit
controls, according to the user operation:
correlation of the notification position with a position where the service is provided;
correlation of an indicator of a degree of interest in the service and content used in notifying a user terminal of the service; and
correlation, with the notification position, of the indicator and the content correlated with the indicator.

20. An information processing program for a processor to execute:
an input control step of performing control corresponding to a user operation;
a display control step of causing a display unit to display information; and
a communication step of performing communication via a network, wherein
the input control step
arranges, with respect to map information indicating a service providing region for providing a service corresponding to a degree of interest of a service recipient, according to the user operation, a notification position for providing notification of information concerning the service and transmits the map information in which the notification position is arranged to the network.
